(19) United States
(12) Patent Application Publication
(10) Pub. No.: US 2014/0192884 A1
(43) Pub. Date: Jul. 10, 2014

(54) Method and device for processing prediction information for encoding or decoding at least part of an image

(71) Applicant: CANON KABUSHIKI KAISHA, Tokyo (JP)

(72) Inventors: GUILLAUME LAROCHE, MELESSE (FR); EDOUARD FRANÇOIS, BOURG DES COMPTES (FR); CHRISTOPHE GISQUET, RENNES (FR); PATRICE ONNO, RENNES (FR)

(73) Assignee: CANON KABUSHIKI KAISHA, Tokyo (JP)

(21) Appl. No.: 14/144,323

(22) Filed: Dec. 30, 2013

(30) Foreign Application Priority Data
Jan. 4, 2013 (GB) 1300146.6

(51) Int. Cl. H04N 19/51

(52) U.S. Cl. CPC H04N 19/00684
USPC 375/240.16

(57) ABSTRACT

A method of processing prediction information for encoding or decoding at least part of an image of an enhancement layer of video data, the video data including the enhancement layer and a base layer, the enhancement layer being composed of processing blocks and the base layer being composed of elementary units each having associated prediction data, the method comprising for a processing block of the enhancement layer: obtaining prediction data of at least a co-located elementary unit of the reference data, the prediction data defining first predictors; and generating, from said prediction data obtained, further predictors for prediction of the current processing block.

PRIORITY CLAIM/INCORPORATION BY REFERENCE

This application claims the benefit under 35 U.S.C. §119(a)-(d) of United Kingdom Patent Application No. 1300146.6, filed on 4 Jan. 2013 and entitled “METHOD AND DEVICE FOR PROCESSING PREDICTION INFORMATION FOR ENCODING OR DECODING AT LEAST PART OF AN IMAGE”. The above cited patent application is incorporated herein by reference in its entirety.

### FIELD OF THE INVENTION

The present invention concerns a method and device for processing prediction information for encoding or decoding at least part of an image.

The present invention further concerns a method and a device for encoding at least part of an image and a method and device for decoding at least part of an image. In embodiments of the invention the image is composed of blocks of pixels and is part of a digital video sequence.

Embodiments of the invention relate to the field of scalable video coding, in particular to scalable video coding applicable to the High Efficiency Video Coding (HEVC) standard.

### BACKGROUND OF THE INVENTION

Video data is typically composed of a series of still images which are shown rapidly in succession as a video sequence to give the idea of a moving image. Video applications are continuously moving towards higher and higher resolution. A large quantity of video material is distributed in digital form over broadcast channels, digital networks and packaged media, with a continuous evolution towards higher quality and resolution (e.g. higher number of pixels per frame, higher frame rate, higher bit-depth or extended color gamut). This technological evolution puts higher pressure on the distribution networks that are already facing difficulties in bringing HDTV resolution and high data rates economically to the end user.

Video coding is a way of transforming a series of video images into a compact bitstream so that the capacities required for transmitting and storing the video images can be reduced. Video coding techniques typically use spatial and temporal redundancies of images in order to generate data bit streams of reduced size compared with the original video sequences. Spatial prediction techniques (also referred to as Intra coding) exploit the mutual correlation between neighbouring image pixels, while temporal prediction techniques (also referred to as INTER coding) exploit the correlation between images of sequential images. Such compression techniques render the transmission and/or storage of the video sequences more effective since they reduce the capacity required of a transfer network, or storage device, to transmit or store the bit-stream code.

An original video sequence to be encoded or decoded generally comprises a succession of digital images which may be represented by one or more matrices the coefficients of which represent pixels. An encoding device is used to code the video images, with an associated decoding device being available to reconstruct the bit stream for display and viewing.

Common standardized approaches have been adopted for the format and method of the coding process. One of the more recent standards is Scalable Video Coding (SVC) in which a video image is split into smaller sections (often referred to as macroblocks or blocks) and treated as being comprised of hierarchical layers. The hierarchical layers include a base layer, corresponding to lower quality images (or frames) of the original video sequence, and one or more enhancement layers (also known as refinement layers) providing better quality, images in terms of spatial and/or temporal enhancement compared to base layer images. SVC is a scalable extension of the H.264/AVC video compression standard. In SVC, compression efficiency can be obtained by exploiting the redundancy between the base layer and the enhancement layers.

A further video standard being standardized is HEVC, in which the macroblocks are replaced by so-called Coding Units and are partitioned and adjusted according to the characteristics of the original image segment under consideration. This allows more detailed coding of areas of the video image which contain relatively more information and less coding effort for those areas with fewer features.

The video images may be processed by coding each smaller image portion individually, in a manner resembling the digital coding of still images or pictures. Different coding models provide prediction of an image portion in one frame, from a neighboring image portion of that frame, by association with a similar portion in a neighboring frame, or from a lower layer to an upper layer (referred to as “inter-layer prediction”). This allows use of already available coded information, thereby reducing the amount of coding bit-rate needed overall.

In general, the more information that can be compressed at a given visual quality, the better the performance in terms of compression efficiency.

### SUMMARY OF THE INVENTION

The present invention has been devised to address one or more of the foregoing concerns.

According to a first aspect of the invention there is provided a method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:

obtaining prediction data of at least a co-located elementary unit of the reference data, the prediction data defining first predictors; and

generating, from said prediction data obtained, further predictors for prediction of the current processing block, wherein the prediction data comprises motion data indicative of the location of the corresponding predictor in the video data, and in the case where the motion data is bidirectional comprising two motion data sets, the method comprising generating at least one set of unidirectional motion data from the bidirectional motion data for the further predictors.

Coding efficiency of interlayer prediction may thus be improved by using a competition between more base mode predictors.

In an embodiment, the predictor is selected from the further predictors of the unidirectional data for prediction of the processing block.

In an embodiment, if one of the two motion data sets is missing (the motion data may be considered in this case to be unidirectional) the further predictors are derived from the single motion data set to provide at least a second motion data set (the data may then be considered in this case to be bidirectional).

In an embodiment, motion vectors of a reference frame in the single motion data set are scaled to the corresponding reference frame of the second motion data set.

In an embodiment, if a frame reference of the single motion data set refers to the same reference frame as the second motion data set the frame reference of the second motion data set is changed to another frame reference of the second motion data set.

In an embodiment, the corresponding motion vector of the reference frame defined in the second motion data set is modified in the case where the second motion data set defines only one reference frame.

In an embodiment, the method includes scaling motion vectors of the predictors to obtain motion vectors of the further predictors.

In an embodiment, prediction data is obtained from each sub-unit of the co-located elementary unit for generation of the second set of candidate predictors.

In an embodiment, prediction data is obtained from one or more sub-units neighbouring the co-located elementary unit for generation of the further predictors.

In an embodiment, prediction data is obtained from one or more sub-processing blocks of the enhancement layer neighbouring the said processing block for generation of the further predictors.

In an embodiment, prediction data is obtained from a temporal co-located elementary unit for generation of the further predictors.

In an embodiment, a predictor from the further predictors is selectable as for a predictor for use in AMVP or merge mode processes

A further aspect of the invention provides a method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:

obtaining prediction data of at least a co-located elementary unit of the reference data, the prediction data defining first predictors; and

generating, from said prediction data obtained, further predictors for prediction of the current processing block.

wherein the prediction data comprises motion data indicative of the location of the corresponding predictor in the video data and at least two predictors of the further predictors are generated from a motion vector of the motion data by application of at least two different respective motion compensation processes.

In an embodiment at least one of the motion compensation processes comprises predicting a temporal residual of the enhancement layer processing block from a temporal residual computed between a collocated elementary unit of the base layer and a reference elementary unit of the base layer determined in accordance with motion information of the enhancement layer.

In an embodiment the said at least one motion compensation process is defined respectively by at least one of the following expressions:

PRED_{EL}=MC₁[REF_{EL},MV_{EL}]+{UPS[REC_{BL}−MC₄[REF_{BL},MV_{EL}/2]]}

PRED_{EL}=λMC₁[REF_{EL},MV_{EL}]+α{UPS[REC_{BL}−βMC₄[REF_{BL},MV_{EL}/2]]}

PRED_{EL}=MC₁[REF_{EL},MV_{EL}]+{UPS[REC_{BL}]−FILT₁(MC₂[UPS[REF_{BL}],MV_{EL}])}

PRED_{EL}=UPS[REC_{BL}]+FILT₁(MC₃[REF_{EL}−UPS[REF_{BL}],MV_{EL}])

PRED_{EL}=MC₁[REF_{EL},MV_{EL}]+FILT₁({UPS[REC_{BL}−MC₄[REF_{BL},MV_{EL}/2]]})

PRED_{EL}=FILT₂(MC₁[REF_{EL},MV_{EL}])+{UPS[REC_{BL}]−FILT₁(MC₂[UPS[REF_{BL}],MV_{EL}])}

PRED_{EL}=FILT₂(UPS[REC_{BL}])+FILT₁(MC₃[REF_{EL}−UPS[REF_{BL}],MV_{EL}])

PRED_{EL}=FILT₂(MC₁[REF_{EL},MV_{EL}])+FILT₁({UPS[REC_{BL}−MC₄[REF_{BL},MV_{EL}/2]]}

where:

PRED_{EL} corresponds to the prediction of the current processing block,

REC_{BL} is the co-located elementary unit from the reconstructed base layer image, corresponding to the current enhancement layer,

MV_{EL} is the motion vector used for the temporal prediction in the enhancement layer

REF_{EL} is the reference enhancement layer image,

REF_{BL} is the reference base layer image,

UPS[x] is the upsampling operator for upsampling from the base layer to the enhancement layer

MC₁[x,y] is the enhancement layer operator performing the motion compensated prediction from image x using motion vector y

MC₂[x,y] is the base layer operator performing the motion compensated prediction from image x using the motion vector y

In an embodiment, the said at least one motion compensation process is defined by

PRED_{EL}=λMC₁[REF_{EL},MV_{EL}]+α{UPS[REC_{BL}−βMC₄[REF_{BL},MV_{EL}/2]]}

wherein at least one of the parameters λ, α, β is varied to obtain a plurality of predictor candidates for the further predictors.

In an embodiment, the plurality of predictors obtained by the plurality of motion compensation processes are averaged to obtain a candidate predictor.

A further aspect of the invention provides a method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:

obtaining prediction data of at least a co-located elementary unit of the reference data, the prediction data defining first predictors; and

generating, from said prediction data obtained, further predictors for prediction of the current processing block.

wherein at least one filtering process is applied to one or more predictors of the first predictors to obtain the further predictors

In an embodiment, the filtering process comprises at least one filter selected from the group of deblocking filter, SAO filter, ALF filter, and Weiner filter

In any embodiment of the first, second or third aspects, the number of unique predictor candidates, is determined, among the first predictors and further predictors, or among the further predictors.

In any embodiment of the first, second or third aspects, the method includes selecting, based on a rate-distortion criteria, a predictor from among the first predictors and the further predictors.

In any embodiment of the first, second or third aspects, the method includes selecting, based on a rate-distortion criteria, a predictor from among the further predictors.

In an embodiment the method includes signalling indicator data representative of the selected predictor.

In an embodiment the indicator data comprises an index coded by a unary max code wherein the maximum value is set to a fixed value

In any embodiment of the first, second or third aspects, the method includes identifying unique predictors of the first predictors.

In any embodiment of the first, second or third aspects the method includes identifying unique predictors of the further predictors.

In any embodiment of the first, second or third aspects the method includes identifying if the at least one co-located elementary unit of the base layer has a block residual.

In an embodiment predicted border processing blocks are compared with reconstructed border processing blocks and the predictor providing the minimum distortion between the predicted and the reconstructed border processing blocks is selected.

A fourth aspect of the invention provides a device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:

a prediction data extractor for obtaining, for a processing block of the enhancement layer, prediction data of at least a co-located elementary unit of the reference data, the prediction data defining first predictors; and

a predictor data generator for generating, from said prediction data obtained, further predictors for prediction of the current processing block;

wherein the prediction data comprises motion data indicative of the location of the corresponding predictor in the video data, and in the case where the motion data is determined to be bidirectional comprising two motion data sets, the predictor data generator is configured to generate at least one set of unidirectional motion data from the bidirectional motion data for the further predictors.

In an embodiment, the predictor is selected from the further predictors of the unidirectional data for prediction of the processing block.

In an embodiment, the motion data is determined to be unidirectional comprising a single motion data set, the predictor data generator is configured to derive the further predictors from the single motion data set to provide at least a second motion data set. In an embodiment, a scaler is provided for scaling motion vectors of a reference frame in the single motion data set to the corresponding reference frame of the second motion data set.

In an embodiment, if a frame reference of the single motion data set refers to the same reference frame as the second motion data set the frame reference of the second motion data set is changed to another frame reference of the second motion data set.

In an embodiment, the corresponding motion vector of the reference frame defined in the second motion data set is modified in the case where the second motion data set defines only one reference frame.

In an embodiment, a motion vector scaler is provided for scaling motion vectors of the first motion data set to obtain motion vectors of the further predictors.

In an embodiment, the prediction data extractor is configured to obtain prediction data from each sub-unit of the co-located elementary unit for generation of the further predictors.

In an embodiment, the prediction data extractor is configured to obtain prediction data from one or more sub-units neighbouring the co-located elementary unit for generation of the further predictors.

In an embodiment, the prediction data extractor is configured to obtain prediction data from one or more sub-processing blocks of the enhancement layer neighbouring the said processing block for generation of the further predictors.

In an embodiment, the prediction data extractor is configured to obtain prediction data from a temporal co-located elementary unit for generation of the further predictors.

In an embodiment, a predictor from the further predictors is selectable as a predictor for use in AMVP or merge mode processes

A fifth aspect of the invention provides a device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:

a prediction data extractor for obtaining, for a processing block of the enhancement layer, prediction data of at least a co-located elementary unit of the reference data, the prediction data defining first predictors; and

a predictor data generator for generating, from said prediction data obtained, further predictors for prediction of the current processing block;

wherein the prediction data comprises motion data indicative of the location of the corresponding predictor in the video data; and the prediction data generator is configured to obtain a motion vector of the prediction data to generate at least two predictor candidates of the second set by application of at least two different respective motion compensation processes.

In an embodiment at least one of the motion compensation processes comprises predicting a temporal residual of the enhancement layer processing block from a temporal residual computed between a collocated elementary unit of the base layer and a reference elementary unit of the base layer determined in accordance with motion information of the enhancement layer.

In an embodiment the said at least one motion compensation process is defined respectively by at least one of the following expressions:

PRED_{EL}=MC₁[REF_{EL},MV_{EL}]+{UPS[REC_{BL}−MC₄[REF_{BL},MV_{EL}/2]]}

PRED_{EL}=λMC₁[REF_{EL},MV_{EL}]+α{UPS[REC_{BL}−βMC₄[REF_{BL},MV_{EL}/2]]}

PRED_{EL}=MC₁[REF_{EL},MV_{EL}]+{UPS[REC_{BL}]−FILT₁(MC₂[UPS[REF_{BL}],MV_{EL}])}

PRED_{EL}=UPS[REC_{BL}]+FILT₁(MC₃[REF_{EL}−UPS[REF_{BL}],MV_{EL}])

PRED_{EL}=MC₁[REF_{EL},MV_{EL}]+FILT₁({UPS[REC_{BL}−MC₄[REF_{BL},MV_{EL}/2]]})

PRED_{EL}=FILT₂(MC₁[REF_{EL},MV_{EL}])+{UPS[REC_{BL}]−FILT₁(MC₂[UPS[REF_{BL}],MV_{EL}])}

PRED_{EL}=FILT₂(UPS[REC_{BL}])+FILT₁(MC₃[REF_{EL}−UPS[REF_{BL}],MV_{EL}])

PRED_{EL}=FILT₂(MC₁[REF_{EL},MV_{EL}])+FILT₁({UPS[REC_{BL}−MC₄[REF_{BL},MV_{EL}/2]]}

where:

PRED_{EL} corresponds to the prediction of the current processing block,

REC_{BL} is the co-located elementary unit from the reconstructed base layer image, corresponding to the current enhancement layer,

MV_{EL} is the motion vector used for the temporal prediction in the enhancement layer

REF_{EL} is the reference enhancement layer image,

REF_{BL} is the reference base layer image,

UPS[x] is the upsampling operator for upsampling from the base layer to the enhancement layer

MC₁[x,y] is the enhancement layer operator performing the motion compensated prediction from image x using motion vector y

MC₂[x,y] is the base layer operator performing the motion compensated prediction from image x using the motion vector y

In an embodiment, the said at least one motion compensation process is defined by

PRED_{EL}=λMC₁[REF_{EL},MV_{EL}]+α{UPS[REC_{BL}−βMC₄[REF_{BL},MV_{EL}/2]]}

the device further comprising means to vary at least one of the parameters λ, α, β to obtain a plurality of predictor candidates for the further predictors.

In an embodiment, the plurality of predictors obtained by the plurality of motion compensation processes are averaged to obtain a candidate predictor.

A further aspect of the invention provides a device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:

a prediction data extractor for obtaining, for a processing block of the enhancement layer, prediction data of at least a co-located elementary unit of the reference data, the prediction data defining first predictors;

a predictor data generator for generating, from said prediction data obtained, further predictors for prediction of the current processing block; and

a filter for applying at least one filtering process to one or more predictors of the first set of predictors to obtain the further predictors.

In an embodiment the filtering process comprises at least one filter selected from the group of deblocking filter, SAO filter, ALF filter, and Weiner filter

In an embodiment, a processor is provided for determining the number of unique predictor candidates in the first and further predictor candidates, or in the further predictor candidates

In an embodiment, a selector is provided for selecting, based on a rate-distortion criteria, a predictor candidate from among the first set of predictors and the further predictors.

In an embodiment a selector is provided for selecting, based on a rate-distortion criteria, a predictor candidate from among the further predictors.

In an embodiment, signalling means are provided for signalling indicator data representative of the selected predictor candidate.

In an embodiment, the indicator data comprises an index coded by a unary max code wherein the maximum value is set to a fixed value

In an embodiment, a unique predictor identifier is provided for identifying unique predictors of the first set of predictors.

In an embodiment, a unique predictor identifier is provided for identifying unique predictors of the further predictors.

In an embodiment, a block residual identifier is provided for identifying if the at least one co-located elementary unit of the base layer has a block residual.

In an embodiment, a comparator, is provided, for comparing predicted border processing blocks with reconstructed border processing blocks wherein the selector is configured to select the predictor providing the minimum distortion between the predicted and the reconstructed border processing blocks.

A further aspect of the invention provides a method of determining prediction information for encoding or decoding at least part of an image of an enhancement layer of video data, the video data including the enhancement layer and a base layer, the enhancement layer being composed of processing blocks and the base layer being composed of elementary units each having associated base layer prediction information, the method comprising

obtaining the prediction information of the collocated elementary units in the base layer which at least partly spatially correspond to the processing block, each prediction information allowing determination of at least one predictor for the processing block in the enhancement layer, and

determining, based on at least a pre-determined quantity of prediction information authorized for the processing block, whether to use all the predictors or a selected part of the predictors.

In an embodiment, the determining step is also based on prediction constraints on the enhancement layer's processing blocks.

In an embodiment, the selected part of the predictors comprise one predictor associated to the portion of the processing block being the closest to the bottom right corner of the processing block in the enhancement layer.

A yet further aspect of the invention provides a method of determining prediction information for encoding or decoding at least part of an image of an enhancement layer of video data, the video data including the enhancement layer and a base layer, the enhancement layer being composed of processing blocks and the base layer being composed of elementary units, the method comprising for each enhancement layer's processing block

determining interlayer predictors from the collocated base layer's elementary units for processing the processing blocks, taking into account prediction constraints on the processing blocks.

In an embodiment there is one determined interlayer predictor per enhancement layer processing block, the determined interlayer predictor being associated with the portion of the processing block which is the closest to the bottom right corner of the processing block.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 schematically illustrates an example of the architecture of a video encoder.

FIG. 2 schematically illustrates an example of the architecture of a video decoder.

FIG. 3 schematically illustrates an example of the architecture of a video scalable encoder.

FIG. 4 schematically illustrates an example of the architecture of a video scalable decoder.

FIG. 5 schematically illustrates an example of examples of scalable coding mode.

FIG. 6A schematically illustrates an of GRILP motion compensation

FIG. 6B is a flow chart of GRILP motion compensation in accordance with an embodiment of the invention;

FIG. 7 schematically illustrates an example of implementation of a GRILP mode.

FIG. 8 schematically illustrates another example of implementation of GRILP mode.

FIG. 9 schematically illustrates an example of the neighboring positions blocks used to generate motion vector predictors in AMVP and Merge of HEVC

FIG. 10 schematically illustrates an example of the derivation process of motion vector predictors in AMVP.

FIG. 11 schematically illustrates an example of the derivation process of motion candidates in Merge.

FIG. 12 schematically illustrates an example of the neighboring positions blocks used to generate motion vector predictors in AMVP and Merge for scalable video coding.

FIG. 13 schematically illustrates an example of the derivation process of motion vector predictors in AMVP for scalable video coding.

FIG. 14 schematically illustrates a method of generation of motion candidates for several base mode predictors in accordance with an embodiment of the present invention.

FIG. 15 schematically illustrates a method of generation of motion candidates for several base mode predictors in accordance with another embodiment of the present invention.

FIG. 16 schematically illustrates an example of collocated block partitioning in the base layer.

FIG. 17 schematically illustrates a method of generation of motion candidates for several base mode predictors in accordance with another embodiment of the present invention.

FIG. 18 schematically illustrates an example of collocated block partitioning and its neighbouring partitions in the base layer.

FIG. 19 schematically illustrates a method of generation of motion candidates for several base mode predictors in accordance with another embodiment of the present invention.

FIG. 20 schematically illustrates a base layer frame and an enhancement layer frame in accordance with an embodiment of the invention;

FIG. 21A schematically illustrates a data communication system in which one or more embodiments of the invention may be implemented;

FIG. 21B is a schematic block diagram illustrating a processing device configured to implement at least one embodiment of the present invention;

### DETAILED DESCRIPTION OF THE INVENTION

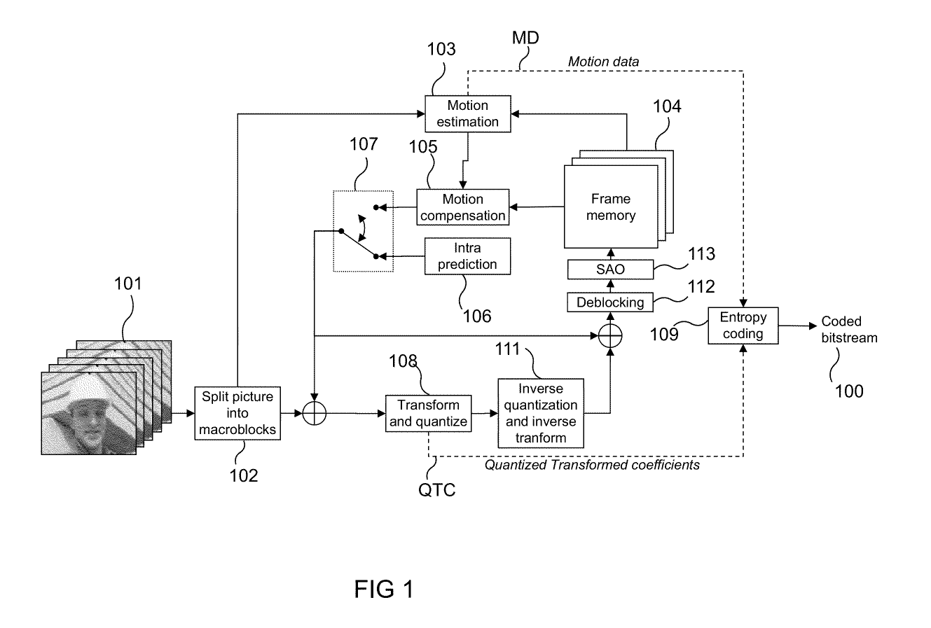

FIG. 1 is a block diagram illustrating a standard video encoding device, of a generic type, conforming to a HEVC or H.264/AVC video compression system. The input to this non-scalable encoder includes an original sequence of frame images 101 to be compressed into a video bit-stream. The encoder successively performs the following steps to encode a standard video bit-stream. A first picture or frame to be encoded (compressed) is divided into pixel blocks, called coding units in the HEVC standard. The first picture is thus split into blocks or macroblocks 102. Each block firstly undergoes a motion estimation operation 103, which comprises a search, among reference pictures stored in a dedicated memory buffer 104, for reference blocks that would provide a good prediction of the block to be encoded. This motion estimation step provides one or more reference picture indexes which indicate the pictures containing the reference blocks considered as suitable predictors, as well as the corresponding motion vectors. A motion compensation step 105 then applies the estimated motion vectors to the found reference blocks and copies the so-obtained blocks into a temporal prediction picture. Then, an Intra prediction step 106 determines the spatial prediction mode that would provide the best performance for predicting the current block and encoding it in INTRA mode.

Then, a coding mode selection mechanism 107 selects the coding mode, from among the spatial and temporal prediction modes, which provides the best rate distortion trade-off in the coding of the current block. The difference between the current block 102 (in its original version) and the so-chosen prediction block (not shown) is calculated. This provides a (temporal or spatial) residual to be compressed. The residual block then undergoes a transform (DCT) and a quantization 108. Entropy coding 109 of the so-quantized coefficients QTC (and associated motion data MD) is performed. The compressed texture data 100 associated with the coded current block 102 is then sent for output.

The current block is then reconstructed by scaling and inverse transform (111). This step is followed (if required) by a sum between the inverse transformed residual and the prediction block of the current block in order to form a reconstructed block. The reconstructed blocks are added to the buffer in order to form the reconstructed frame. This reconstructed frame is then filtered. The current HEVC standard includes 2 post filterings, the deblocking filter (112) followed by the sample adaptive offset (SAO) (113). The reconstructed frame after these 2 post filters is stored in a memory buffer 104 (the DPB, Decoded Picture Buffer) so that it is available for use as a reference picture in the prediction of any subsequent pictures to be encoded. It should be noted that the loop filtering can be applied block by block or LCU by LCU in the HEVC standard. However, the post filtered pixels of LCU are not used as reference pixels for Intra prediction.

Finally, a last entropy coding step 109 is given the coding mode and, in case of an inter block, the motion data, as well as the quantized DCT coefficients previously calculated. This entropy coder 109 encodes each of these data into their binary form and encapsulates the so-encoded block into a container called NAL unit (Network Abstract Layer). A NAL unit contains all encoded coding units from a given slice. A coded HEVC bit-stream includes a series of NAL units.

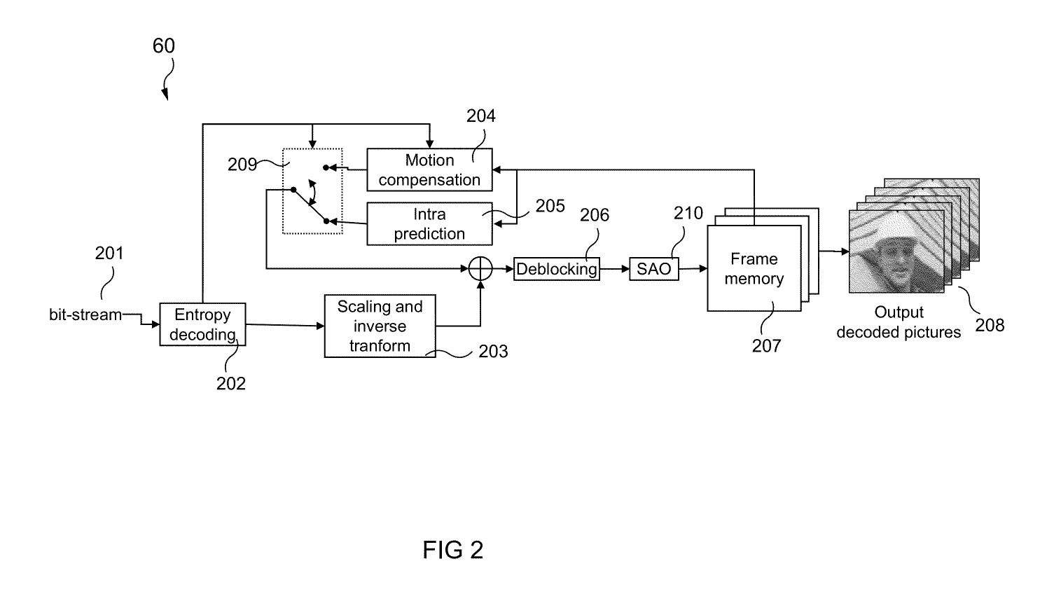

FIG. 2 is a block diagram of a standard HEVC or H.264/AVC decoding system. This decoding process of a H.264 bit-stream 201 starts by the entropy decoding 202 of each block (array of pixels) of each coded picture in the bit-stream. This entropy decoding provides the coding mode, the motion data (reference pictures indexes, motion vectors of INTER coded blocks), residual data and SAO filter parameters. The residual data includes quantized and transformed DCT coefficients. Next, these quantized DCT coefficients undergo inverse quantization (scaling) and inverse transform operations 203.

The decoded residual is then added to the temporal (Inter) (204) or spatial (Intra) (205) prediction block of the current block, to provide the reconstructed block. The prediction mode information which is provided by the entropy decoding step mode extracted from the bitstream indicates if the current block is Intra or Inter (209).

The reconstructed block finally undergoes one or more in-loop post-filtering processes, e.g. deblocking (206) and SAO (207), which aim at reducing the blocking artefact inherent to any block-based video codec (deblocking), and improving the quality of the decoded picture.

The full post-filtered picture is then stored in the Decoded Picture Buffer (DPB), represented by the frame memory (207), which stores pictures that will serve as references for predicting future pictures to decode. The decoded pictures (208) are also ready to be displayed on screen.

As previously mentioned, video codec exploits both spatial and temporal correlations between pixels by virtue of the Intra and Inter modes. An Intra mode exploits spatial correlation of the pixels within the current frame. The Inter modes exploit temporal correlation between pixels of the current frame and previously encoded/decoded frames.

In the current HEVC design, Inter prediction can be unidirectional or bi-directional. Uni-directional means that one predictor block is used to predict the current block. This predictor block is defined by a list index, a reference frame index and a motion vector. The list index corresponds to a list of reference frames. It may be considered that two lists are used: L0 and L1. A list contains at least one reference frame and a reference frame can be included in both lists. A motion vector has two components: horizontal and vertical. This corresponds to the spatial displacement in term of pixels between the current block and the temporal predictor block in the reference frame. Thus, the block predictor for the uni-directional prediction is the block from the reference frame (ref index) of the list, pointed to by the motion vector.

For Bi-directional Inter prediction, two block predictors are considered. One for each list (L0 and L1). Consequently, two reference frame indexes are considered as well as two motion vectors. The Inter block predictor for bi-prediction is the average, pixel at pixel, of these two blocks pointed by these two motion vectors.

The motion information dedicated to the Inter block predictor can be defined by the following parameters:
A direction type: uni or bi
A list (uni-direction) or two lists (bi-direction): L0, L1, L0 and L1.
One (uni-direction) or two reference frame indexes (bi-direction): RefL0, RefL1, (RefL0, RefL1).
One (uni-direction) or two (bi-direction) motion vectors: each motion vector has two components (horizontal mvₓ and vertical mv_{y}).

A bi-directional Inter predictor is used for a B slice type. Inter prediction in B slices can be uni or bi-directional. For P slices, Inter prediction is uni-directional. Embodiments of the invention may be applied to P and B slices and for both uni and bi-directional Inter predictions.

The current design of HEVC uses 3 different Inter modes: Inter mode, Merge mode and Merge Skip mode. The main difference between these modes is the data signalling in the bitstream.

For Inter modes, all data are explicitly signaled. This means that the texture residual is coded and inserted into the bitstream (the texture residual is the difference between the current block and the Inter prediction block). For the motion information, all data are coded. Thus, the direction type is coded (uni or bi-directional). The list index, if needed, is also coded and inserted into the bitstream. The related reference frame indexes are explicitly coded and inserted into the bitstream. The motion vector value is predicted by the selected motion vector predictor. The motion vector residual for each component is then coded and inserted into the bitstream followed by the predictor index.

For the Merge mode, the texture residual and the predictor index are coded and inserted into the bitstream. The motion vector residual, direction type, list or reference frame index are not coded. These motion parameters are derived from the predictor index. Thus, the predictor is the predictor of all data of the motion information.

For the Merge Skip mode no information is transmitted to the decoder side except the “mode” and the predictor index. The processing is the same as for the Merge mode except that no texture residual is coded or transmitted. The pixel values of a Merge Skip block are the pixel values of the block predictor.

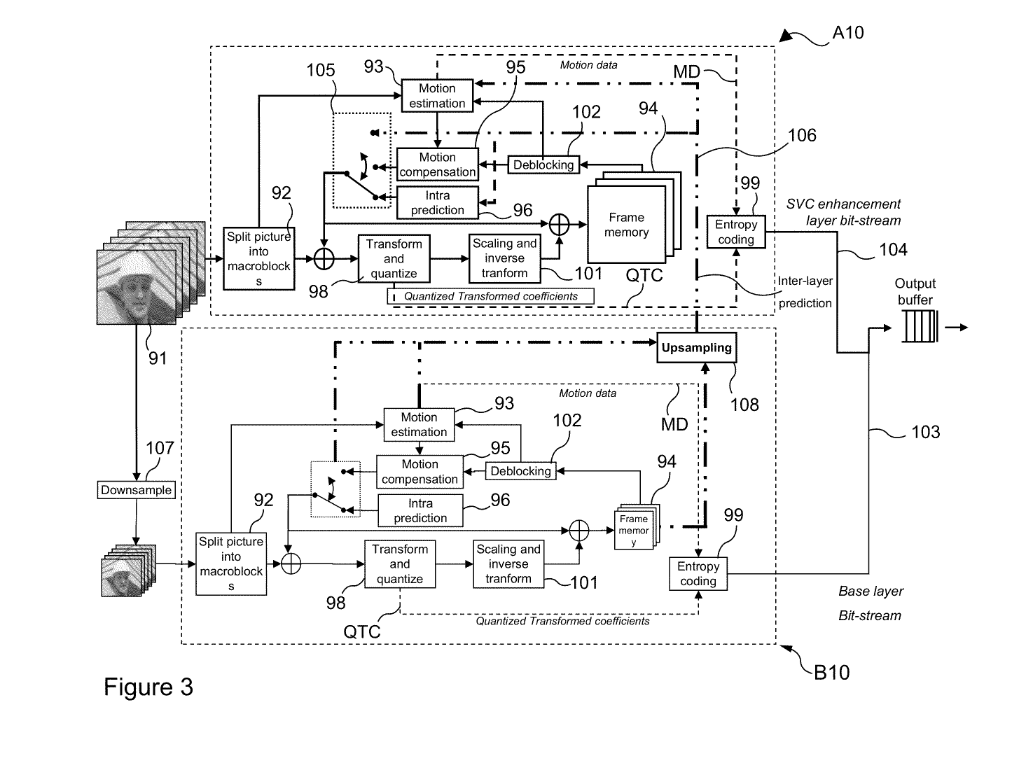

FIG. 3 illustrates a block diagram of a scalable video encoder, comprising a straightforward extension of the standard video coder of FIG. 1, to a scalable video coder. The video encoder may comprise a number of subparts or stages. Illustrated here are two subparts or stages A10 and B10 producing data corresponding to a base layer 103 and data corresponding to one enhancement layer 104. Each of the subparts A10 and B10 follows the principles of the standard video encoder, with the steps of transformation, quantization and entropy coding being applied in two separate paths, one corresponding to each layer.

The first stage B10 aims at encoding the H.264/AVC or HEVC compliant base layer of the output scalable stream, and hence may be identical to the encoder of FIG. 1. Next, the second stage A10 illustrates the coding of an enhancement layer on top of the base layer. This enhancement layer brings a refinement of the spatial resolution to the (down-sampled 107) base layer. As illustrated in FIG. 3, the coding scheme of this enhancement layer is similar to that of the base layer, except that for each coding unit of a current picture 91 being compressed or coded, an additional prediction mode can be chosen by the coding mode selection module 105. This additional coding mode corresponds to an inter-layer prediction mode 106. Inter-layer prediction 106 involves re-using the data coded in a layer lower than current refinement or enhancement layer, as prediction data of the current coding unit. The lower layer used is called the reference layer for the inter-layer prediction of the current enhancement layer. In the case where the reference layer contains a picture that temporally coincides with the current picture, then that picture is referred to as the base picture of the current picture. The co-located block (at same spatial position) of the current coding unit that has been coded in the reference layer can be used as a reference to predict the current coding unit. More precisely, the prediction data that can be used in the co-located block corresponds to the coding mode, the block partition, the motion data (if present) and the texture data (temporal residual or reconstructed block). In the case of a spatial enhancement layer, some up-sampling 108 operations of the texture and prediction data are performed.

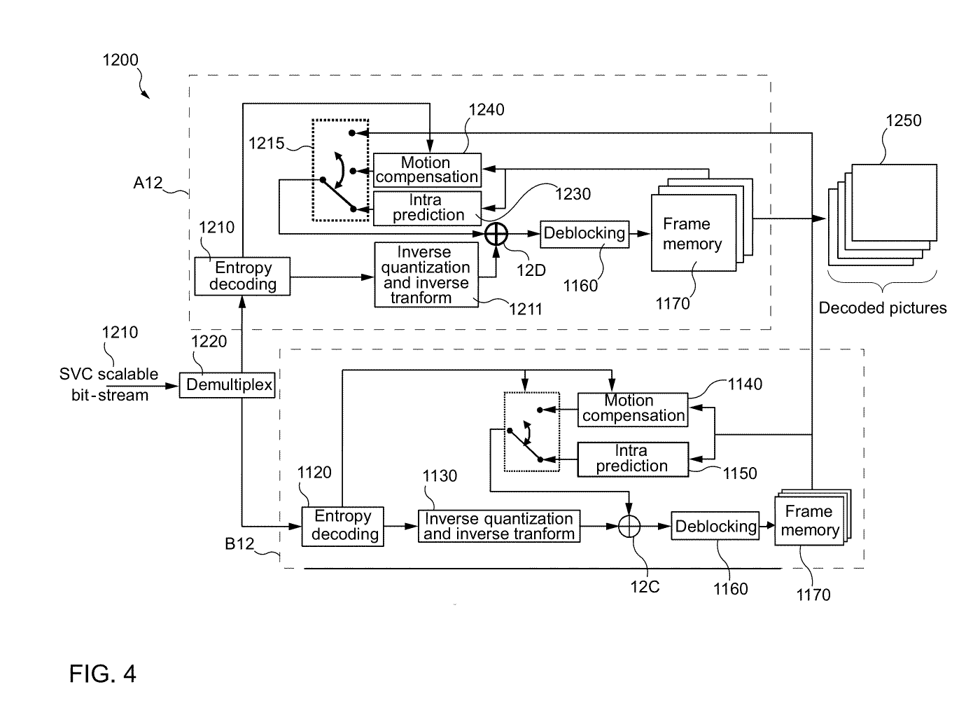

FIG. 4 is a block diagram of a scalable decoder 1200 which may be applied to a scalable bit-stream made of two scalability layers, e.g. comprising a base layer and an enhancement layer. This decoding process is thus the reciprocal processing of the scalable coding process of FIG. 3. The scalable stream being decoded 1210, as shown in FIG. 4, is made of one base layer and one spatial enhancement layer over the base layer, which are demultiplexed 1220 into their respective layers.

The first stage of FIG. 4 concerns the base layer decoding process B12. As previously explained for the non-scalable case, this decoding process starts by entropy decoding 1120 each coding unit or block of each coded picture in the base layer. This entropy decoding 1120 provides the coding mode, the motion data (reference pictures indexes, motion vectors of INTER coded macroblocks) and residual data. This residual data includes quantized and transformed DCT coefficients. Next, these quantized DCT coefficients undergo inverse quantization and inverse transform operations 1130. Motion compensation 1140 or Intra prediction 1150 data can be added 12C.

Deblocking 1160 is then performed and the so-reconstructed residual data is then stored in the frame buffer 1170.

Next, the decoded motion and temporal residual for INTER blocks, and the reconstructed blocks are stored in a frame buffer in the first of the scalable decoder of FIG. 4. Such frames contain the data that can be used as reference data to predict an upper scalability layer.

Next, the second stage of FIG. 4 performs the decoding of a spatial enhancement layer A12 over the base layer decoded by the first stage. This spatial enhancement layer decoding involves the entropy decoding of the second layer 1210, which provides the coding modes, motion information as well as the transformed and quantized residual information of blocks of the second layer.

The next step comprises predicting blocks in the enhancement picture. The choice 1215 between different types of block prediction (INTRA, INTER or inter-layer) depends on the prediction mode obtained from the entropy decoding step 1210.

Treatment of INTRA blocks depends on the type of INTRA coding unit.
In the case of an inter-layer predicted INTRA block (Intra-BL coding mode), the result of the entropy decoding 1210 undergoes inverse quantization and inverse transform 1211, and then is added 12D to the co-located block of the current block in base picture, in its decoded, post-filtered and up-sampled (in case of spatial scalability) version.
In the case of a non-Intra-BL INTRA block, such a block is fully reconstructed, through inverse quantization, inverse transform to obtain the residual data in the spatial domain, and then INTRA prediction 1230 to obtain the fully reconstructed block 1250.

Concerning INTER blocks, their reconstruction involves their motion compensated 1240 temporal prediction, the residual data decoding and then the addition of their decoded residual information to their temporal predictor. In this INTER block decoding process, inter-layer prediction can be used in two ways. First, the motion vectors associated with the considered block can be decoded in a predictive way, as a refinement of the motion vector of the co-located block in the base picture. Second, the temporal residual can also be inter-layer predicted form the temporal residual of the co-sited block in the base layer.

It may be noted that in a particular scalable coding mode of the block all the prediction information of the block (e.g. coding mode, motion vector) may be fully inferred from the co-located block in the base picture. Such a block coding mode is known as so-called “base mode”.

As previously described, the enhancement layer in scalable video coding can use data from the base layer in Intra and Inter coding. The modes which use data from the base layer are known as Inter layer modes. Previously several Inter layer modes or Hybrid Inter layer and Intra or Inter coding modes have been defined.

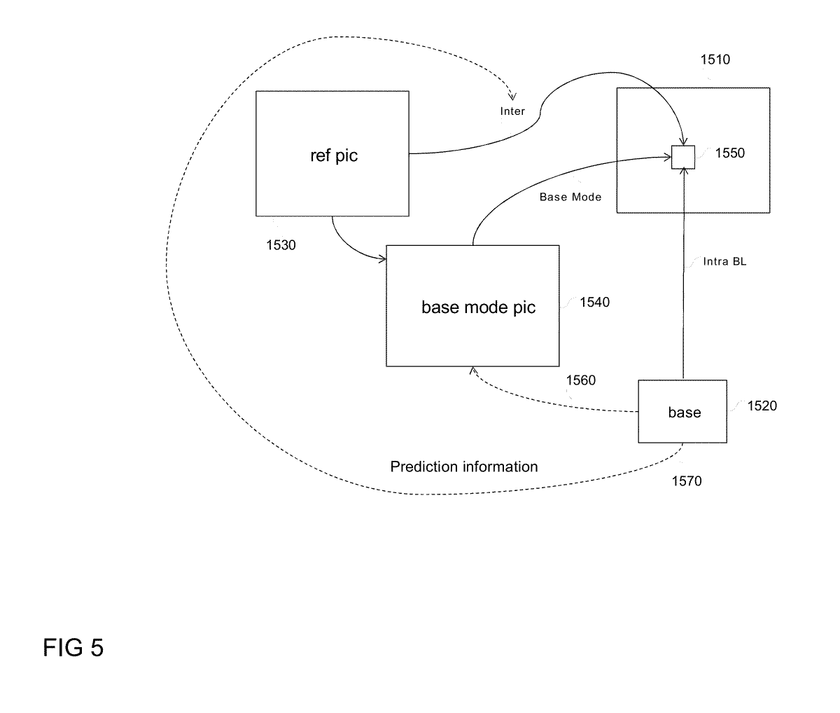

FIG. 5 schematically illustrates prediction modes that can be used in the proposed scalable codec architecture, according to an embodiment of the invention, used to predict a current enhancement picture. Schematic 1510 corresponds to the current enhancement to predict. The base picture 1520 corresponds to the base layer decoded picture that temporally coincides with current enhancement picture. Schematic 1530 corresponds to an example reference picture in the enhancement layer used for the temporal prediction of current picture 1510. Finally, schematic 1540 corresponds to the Base Mode prediction picture introduced above.

As illustrated by FIG. 5, and as explained above, the prediction of current enhancement picture 1510 consists in determining, for each block 1550 in current enhancement picture 1510, the best available prediction mode for the that block 1550, considering temporal prediction, Intra BL prediction and base mode prediction.

The Intra BL mode consists in up sampling the pixel values of the decoded base layer. This mode can be applied block by block or for the whole frame.

FIG. 5 schematically illustrates how prediction information contained in the base layer is extracted, and then is used in two different ways.

Firstly, prediction information of the base layer is used to construct 1560 a “Base Mode” prediction picture 1540. It may be appreciated that block by block derivation of the base mode can also be considered.

Secondly, base layer prediction information is used in the predictive coding 1570 of motion vectors in the enhancement layer. Consequently, the INTER prediction mode illustrated on FIG. 5 makes use of the prediction information contained in the base picture 1520. This allows inter-layer prediction of the motion vectors of the enhancement layer, thereby increasing the coding efficiency of the scalable video coding system.

In further embodiments of the invention a Generalized Inter-Layer Prediction (GRP or GRILP) mode maybe applied to generate the second set of candidate predictors. The difference of this mode compared to the previously described modes is the use of the residual difference between the Enhancement layer and the base layer inserted in the block predictors. Generalized Residual Inter-Layer Prediction (GRILP) involves predicting the temporal residual of an INTER coding unit, from a temporal residual computed between reconstructed base images. This prediction method, employed in case of multi-loop decoding, comprises constructing a “virtual” residual in the base layer by applying the motion information obtained in the enhancement layer to the coding unit of the base layer co-located with the coding unit to be predicted in the enhancement layer to identify a predictor co-located to the predictor of the enhancement layer.

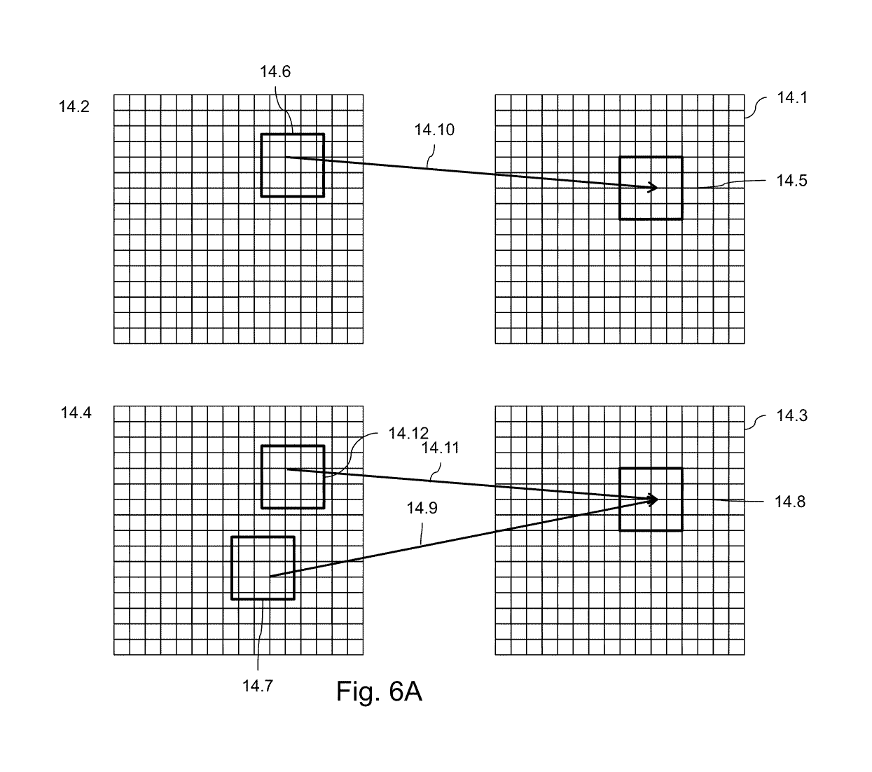

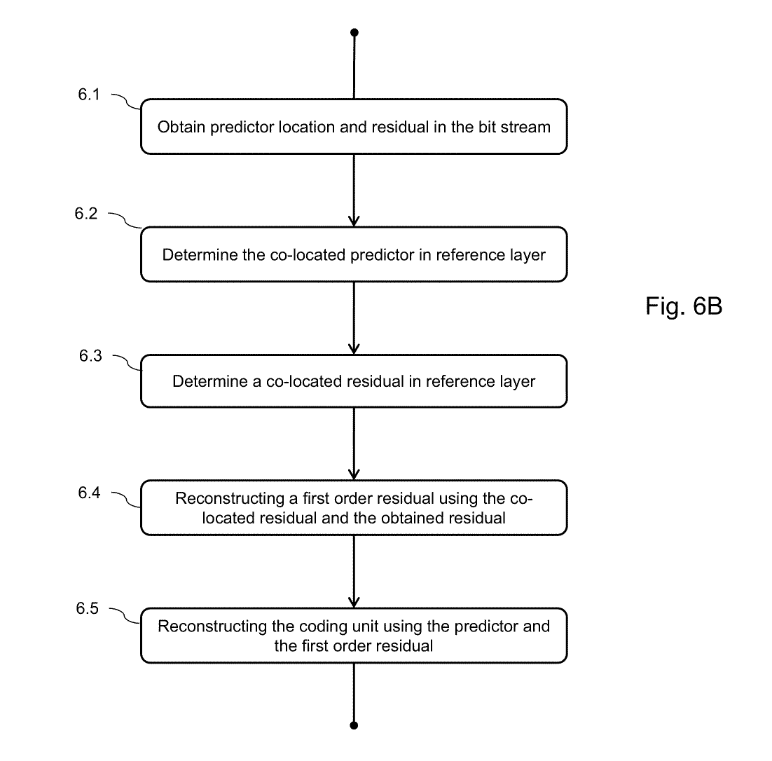

An exemplary mode of GRILP will be described with reference to FIG. 6A The image to be encoded, or decoded, is the image representation 14.1 in the enhancement layer of FIG. 6A. This image is composed of original pixels. Image representation 14.2 in the enhancement layer is available in its reconstructed version. The base layer, depends on the scalable decoder architecture considered. If the encoding mode is single loop, meaning that the base layer reconstruction is not brought to completion, the image representation 14.4 is composed of inter blocks decoded until their residual is obtained but to which motion compensation is not applied and intra blocks which may be integrally decoded as in SVC or partially decoded until their intra prediction residual is obtained as well as a prediction direction. It may be noted that in FIG. 6A, both layers are represented at the same resolution as in SNR scalability. In Spatial scalability, two different layers will have different resolutions which require an up-sampling of the residual and motion information before performing the prediction of the residual.

In the case where the encoding mode is multi loop, a complete reconstruction of the base layer is conducted. In this case, image representation 14.4 of the previous image and image representation 14.3 of the current image both in the base layer are available in their reconstructed version.

A selection is made between all available modes in the enhancement layer to determine a mode optimizing a rate-distortion trade off. The GRILP mode is one of the modes which may be selected for encoding a block of an enhancement layer.

In what follows the described GRILP is adapted to temporal prediction in the enhancement layer. This process starts with the identification of the temporal GRILP predictor.

The flowchart of FIG. 6B illustrates steps of a decoding process of the GRILP mode in accordance with an embodiment of the invention. The bit stream comprises data for locating the predictor and the second order residual. In an initial step 6.1, the location of the predictor used for the prediction of the coding unit and the associated residual are obtained from the bit stream. This residual corresponds to the second order residual obtained at encoding. In a step 6.2, the co-located predictor is determined. This is the location in the reference layer of the pixels corresponding to the predictor obtained from the bit stream. In a step 6.3, the co-located residual is determined. This is defined by the difference between the co-located coding unit and the co-located predictor in the reference layer. In a subsequent step 6.4, the first order residual block is reconstructed by adding the residual obtained from the bit stream which corresponds to the second order residual and the co-located residual. Once the first order residual block has been reconstructed, it is then used with the predictor whose location has been obtained from the bit stream to reconstruct the coding unit in a step 6.5.

Equation 1.1 expresses the GRILP mode process for generating a EL prediction signal PRED_{EL}:

PRED_{EL}=MC₁[REF_{EL},MV_{EL}]+{UPS[REC_{BL}]−MC₂[UPS[REF_{BL}],MV_{EL}]} (1.1)

In this equation,

PRED_{EL} corresponds to the prediction of the EL coding unit being processed,

REC_{BL} is the co-located block from the reconstructed BL picture, corresponding to the current EL picture,

MV_{EL} is the motion vector used for the temporal prediction in the EL

REF_{EL} is the reference EL picture,

REF_{BL} is the reference BL picture,

UPS[x] is the upsampling operator performing the upsampling of samples from picture x; it applies to the BL samples

MC₁[x,y] is the EL operator performing the motion compensated prediction from the picture x using the motion vector y

MC₂[x,y] is the BL operator performing the motion compensated prediction from the picture x using the motion vector y

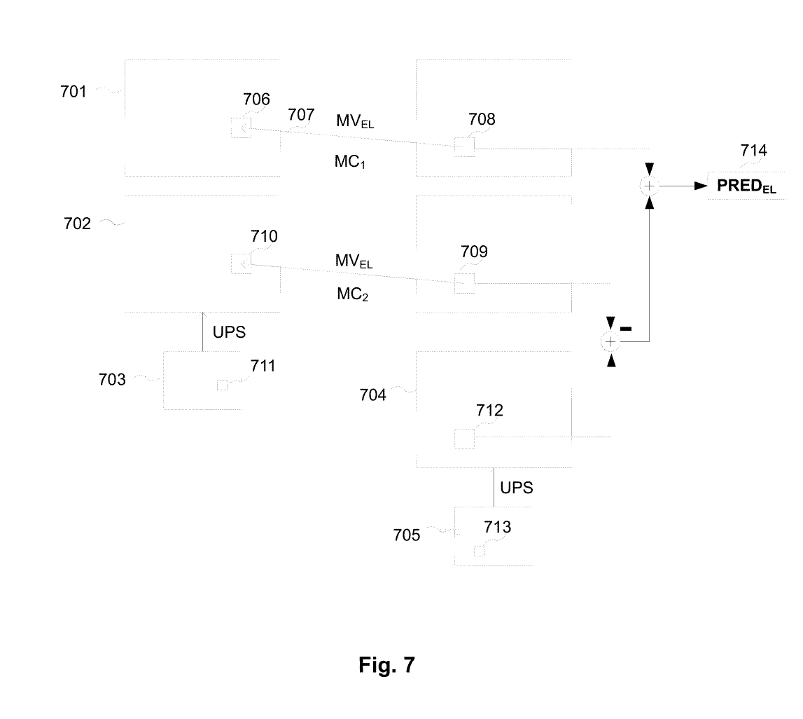

This is illustrated in FIG. 7. Considering that the final block in the EL picture is of size H lines×W columns, its corresponding block in the BL picture is of size h lines×w columns. W/w and H/h then correspond to the inter-layer spatial resolution ratios. The block 708 (of size H×W) is obtained by motion compensation MC1 of a block 706 (of size H×W) from the reference EL picture REFEL 701 using the motion vector MVEL 1207. The block 709 (of size H×W) is obtained by motion compensation MC2 of a block 710 (of size H×W) of the upsampled reference BL picture 702 using the same motion vector MVEL 707. The block 710 has been derived by upsampling the block 711 (of size h×w) from the BL reference picture REFBL 703. The block 712 (of size H×W), in the upsampled BL picture 704, is the upsampled version of the block 713 (of size h×w) from the current BL picture RECBL 705. Samples of block 709 are subtracted to samples of block 712 to generate the second order residual, which is added to the block 708 to generate the final EL prediction block 714.

In one particular embodiment, which is advantageous in terms of memory saving, the first order residual block in the reference layer may be computed between reconstructed pictures which are not up-sampled, thus are stored in memory at the spatial resolution of the reference layer.

The computation of the first order residual block in the reference layer then includes a down-sampling of the motion vector considered in the enhancement layer, towards the spatial resolution of the reference layer. The motion compensation is then performed at reduced resolution level in the reference layer, which provides a first order residual block predictor at reduced resolution.

A final inter-layer residual prediction step then involves up-sampling the so-obtained first order residual block predictor, through a bi-linear interpolation filtering for instance. Any spatial interpolation filtering could be considered at this step of the process (examples: 8-Tap DCT-IF, 6-tap DCT-IF, 4-tap SVC filter, bi-linear). This last embodiment may lead to slightly reduced coding efficiency in the overall scalable video coding process, but does not need additional reference picture storing compared to standard approaches that do not implement the present embodiment.

This corresponds to the following equation:

PRED_{EL}=MC₁[REF_{EL},MV_{EL}]+{UPS[REC_{BL}−MC₄[REF_{BL},MV_{EL}/2]]} (1.2)

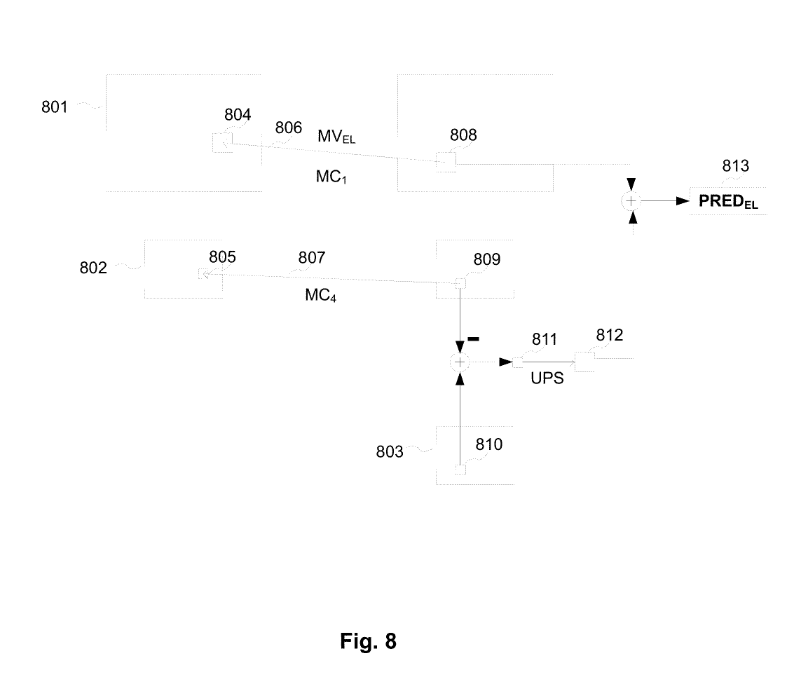

An example of this process is schematically illustrated in FIG. 8. The block 808 (of size H×W) is obtained by motion compensation MC1 of a block 804 (of size H×W) of the reference EL picture REFEL 801 using the motion vector MVEL 806. The block 809 (of size h×w) is obtained by motion compensation MC4 of a block 805 (of size h×w) of the reference BL picture REFBL 802 using the downsampled motion vector MVEL 807. This block 809 is substracted to the BL block 810 (of size h×w) of the BL current picture RECBL 803, collocated with the current EL block, to generate the BL residual block 811 (of size h×w). This BL residual block 811 is then upsampled to obtain the upsampled residual block 812 (of size H×W). The upsampled residual block 812 is finally added to the motion compensated block 808 to generate the prediction PREDEL 813.

Another alternative for generating GRILP block predictor is to weight each part of the linear combination given in equation ((1.2). Consequently, the generic equation for GRILP is:

PRED_{EL}=λMC₁[REF_{EL},MV_{EL}]+α{UPS[REC_{BL}−βMC₄[REF_{BL},MV_{EL}/2]]} (1.3)

It should be noted that in addition to the upsampling and motion compensation processes mentioned above, some filtering operations may be applied to the intermediate generated blocks. For instance, a filtering operator FILTₓ (x taking several possible values for different filters) can be applied directly after the motion compensation, or directly after the upsampling or right after the second order residual prediction block generation. Some examples are provided in equations (1.4) to (1.9):

PRED_{EL}=MC₁[REF_{EL},MV_{EL}]+{UPS[REC_{BL}]−FILT₁(MC₂[UPS[REF_{BL}],MV_{EL}])} (1.4)

PRED_{EL}=UPS[REC_{BL}]+FILT₁(MC₃[REF_{EL}−UPS[REF_{BL}],MV_{EL}]) (1.5)

PRED_{EL}=MC₁[REF_{EL},MV_{EL}]+FILT₁({UPS[REC_{BL}−MC₄[REF_{BL},MV_{EL}/2]]}) (1.6)

PRED_{EL}=FILT₂(MC₁[REF_{EL},MV_{EL}])+{UPS[REC_{BL}]−FILT₁(MC₂[UPS[REF_{BL}],MV_{EL}])} (1.7)

PRED_{EL}=FILT₂(UPS[REC_{BL}])+FILT₁(MC₃[REF_{EL}−UPS[REF_{BL}],MV_{EL}]) (1.8)

PRED_{EL}=FILT₂(MC₁[REF_{EL},MV_{EL}])+FILT₁({UPS[REC_{BL}−MC₄[REF_{BL},MV_{EL}/2]]}) (1.9)

The different processes involved in the prediction process, such as, upsampling, motion compensation, and possibly filtering, are achieved using linear filters applied using convolution operators.

As mentioned above, the Base Mode prediction may use Second order Residual prediction. One way of implementing second order prediction in Base Mode involves using the GRILP mode to generate the base layer motion compensation residue (using the motion vector from the EL downsampled to the BL resolution). This option avoids the storage of the decoded BL residue, since the BL residue can be computed on the fly from the EL MV. In addition this computed residue is guaranteed to fit the EL residue since the same motion vector is used for the EL and BL block.

The current HEVC standard includes a competitive based scheme for Motion vector prediction compared to its predecessors. It means that several candidates are competing with the rate distortion criterion at encoder side in order to find the best motion vector predictor or the best motion information for respectively the Inter or the Merge mode. An index corresponding to the best predictors or the best candidate of the motion information is inserted in the bitstream. The decoder can derive the same set of predictors or candidates and uses the best one according to the decoded index.

The design of the derivation of predictors and candidates is very important to achieve the best coding efficiency without large impact on complexity. In HEVC 2 motion vector derivations are used: one for Inter mode (Advanced Motion Vector Prediction (AMVP)) and one for Merge modes (Merge derivation process). These processes are defined in the following sections.

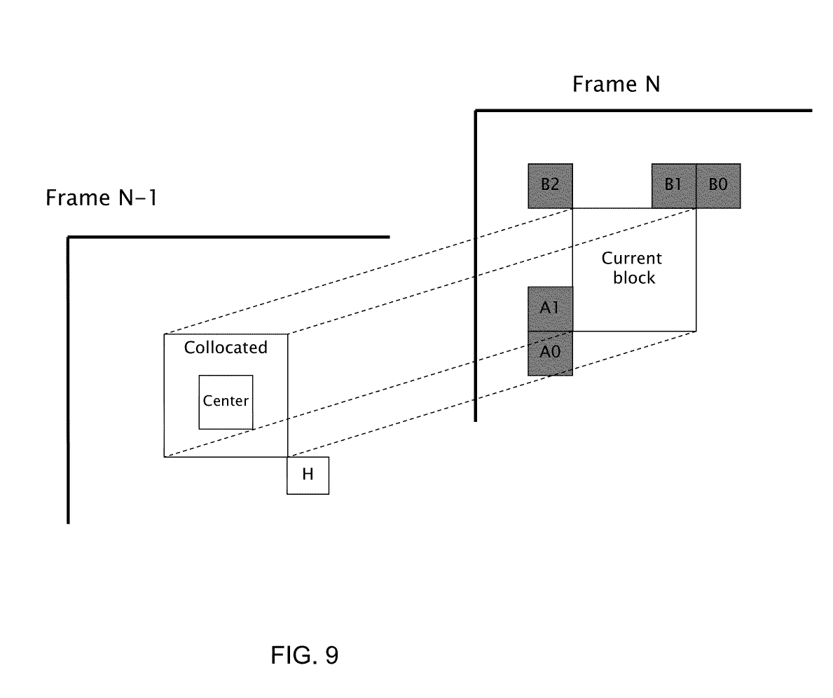

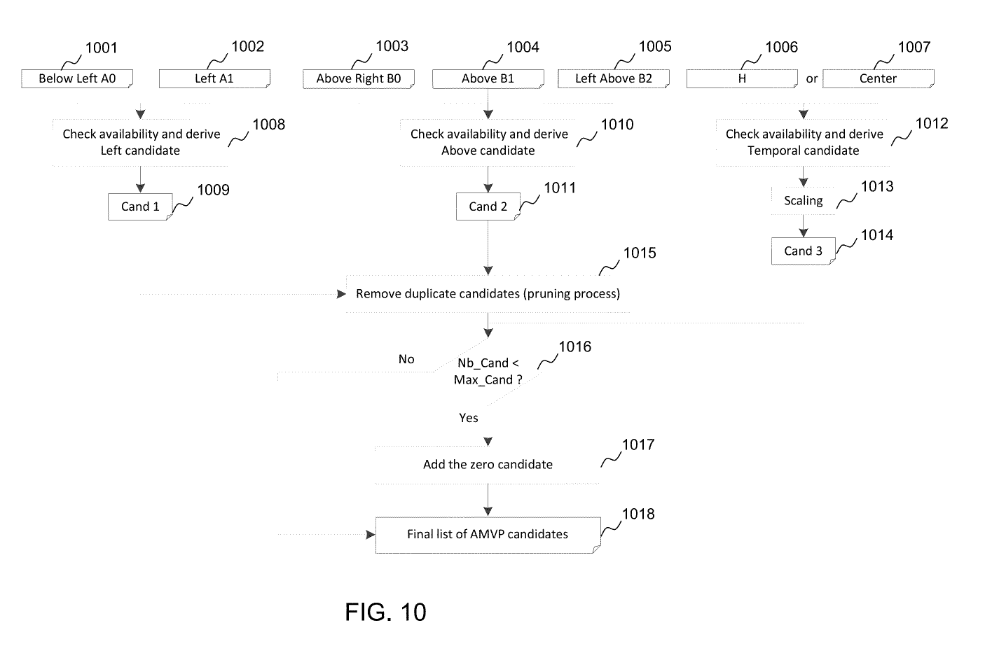

FIGS. 9 and 10 schematically illustrate an example of the derivation of a AMVP predictors set. In the current version of HEVC, the derivation process of AMVP should generate a maximum of 2 motion vector predictors. In that case MAX_cand in FIG. 10 is set to 2. The first spatial candidates is selected from among the left blocks A0 (1001) and A1 (1002). These spatial positions are shown in FIG. 9.

The two spatial motion vectors of the Inter mode are chosen from among those blocks above and on the left of the current block including the above corner blocks and left corner block as represented in FIG. 9.

The left predictor (Cand 1) (1009) is selected (1008) from among the blocks “Below Left” A0 and “Left” A1. In this specific order, the following conditions are evaluated until a motion vector value is found.

1. The motion vector from the same reference list and the same reference picture

2. The motion vector from the other reference list and the same reference picture

The above predictor (1011) is selected (1010) from among “Above Right” B0 (1003), “Above” B1 (1004) and “Above left” B2 (1005) in this specific order, with the same conditions as described below.

Then cand 1 (1009) and cand 2 (1011) are compared in order to remove one of these predictors if they are equal (1015).

The temporal motion predictor cand 3 (1014) is derived as follows: the Bottom right (H) (1006) position is first considered in the availability check module 1012. If this does not exist the center of the collocated block (1007) is selected. These temporal positions (1006 and 1007) are depicted in FIG. 9.

Then the number of added candidates is compared to the Maximum number of candidates (1016). If the Maximum number is reached the final list of AMVP predictor is built (1018) otherwise a zero predictor is added (1017) to the list. (1018). The zero predictor is a motion vector equal to (0,0).

A candidate of Merge modes (“classical” or Skip) represents the motion information: direction, list, and reference frame index and motion vectors. Several candidates are generated by the merge derivation process described in what follows, each having an index. In the current HEVC design the Maximum candidate for both Merge modes is equal to 5.

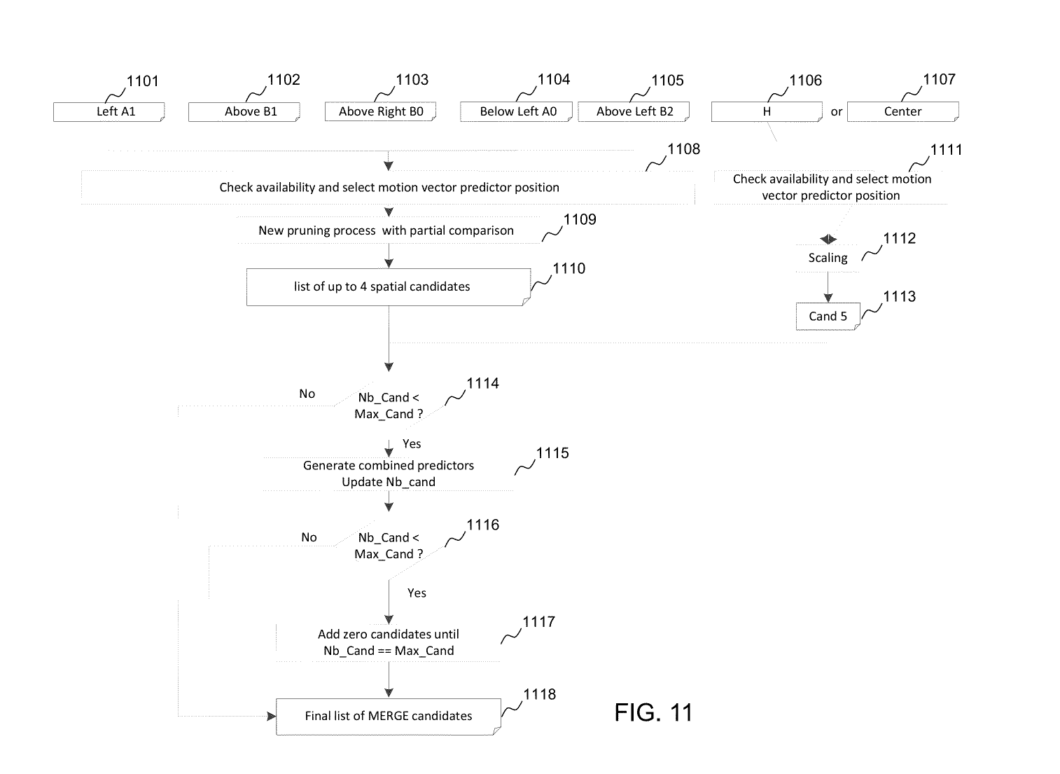

FIG. 11 is a flow chart illustrates steps of an exemplary Motion vector derivation process of the Merge modes. In an initial step of the derivation process, 7 block positions are considered (1101 to 1107). These positions are the spatial and temporal positions depicted in FIG. 9 (each position has the same name in both figures). Module 1108 checks the availability of the spatial motion vectors and selects at most 5 motion vectors. In this module, a predictor is available if it exists and if this block is not Intra coded. The selection and the check of these 5 motion vectors is processed as follows:
If the “Left” A1 motion vector (1101) is available (1108) (if it exists and if this block is not Intra coded), the motion vector of the “Left” block is selected and used as the first candidate in list (1110).
If the “Above” B1 motion vector (1102) is available (1108), the candidate “Above” block is compared (1109) to Al (if it exists). If B1 is equal to A1, B1 is not added to the list of spatial candidates (1110) otherwise it is added.
If the “Above Right” BO motion vector (1103) is available (1108), the motion vector of the “Above Right” is compared (1109) to B1. If B0 is equal to B1, B0 is not added in the list of spatial candidates (1110) otherwise it is added.
If the “Below Left” A0 motion vector (1104) is available (808), the motion vector of the “Below Left” is compared (809) to A1. If A0 is equal to A1, A0 is not added to the list of spatial candidates (810) otherwise it is added.
If the List of spatial candidate does not contain 4 candidates, the availability of “Above Left” B2 motion vector (1105) is tested (1108), if this is available; the motion vector of the “Above Left” B2 is compared (1109) to A1 and B1. If B2 is equal to A1 or B1, B2 is not added to the list of spatial candidates (1110) otherwise it is added.

At the end of this stage the list from 0 up to 4 spatial candidates (1110) is set.

For the temporal candidate, 2 positions can be used: H (1106) corresponding to the bottom right position of the collocated block or the center (1107) of the collocated block (collocated means the block at the same position in the temporal frame). These positions are illustrated in FIG. 9.

As AMVP, first the availability of the block at the H position (1106) is checked (1111). If the block is not available, then the block at the Center position (1107) is then checked (1111). If at least one motion vector of these positions is available, this temporal motion vector can be scaled if needed (1112) to the reference frame with index 0, for both lists L0 and L1 (if needed) in order to create the temporal candidate (1113) which is inserted into the Merge candidates list just after the spatial candidates.

If the amount of candidates (Nb_Cand) (1114) is strictly inferior to the maximum number of candidates Max_Cand the combined candidates are generated (1115) otherwise the final list of Merge candidates is built (1118). The module 1115, is used only when the current frame for B frame, and it (1115) generates several candidates based on the available candidates in the current Merge list. This generation involves combining the My of list L0 from one candidate with the MV of list L1 of a second MV candidate.

If the amount of candidates (Nb_Cand) (1116) is strictly inferior to the maximum number of candidates Max_Cand, the zero motion candidates are generated (1117) until the maximum number of candidates in the Merge list is reached.

At the end of this process the final list of Merge candidates is built (1118).

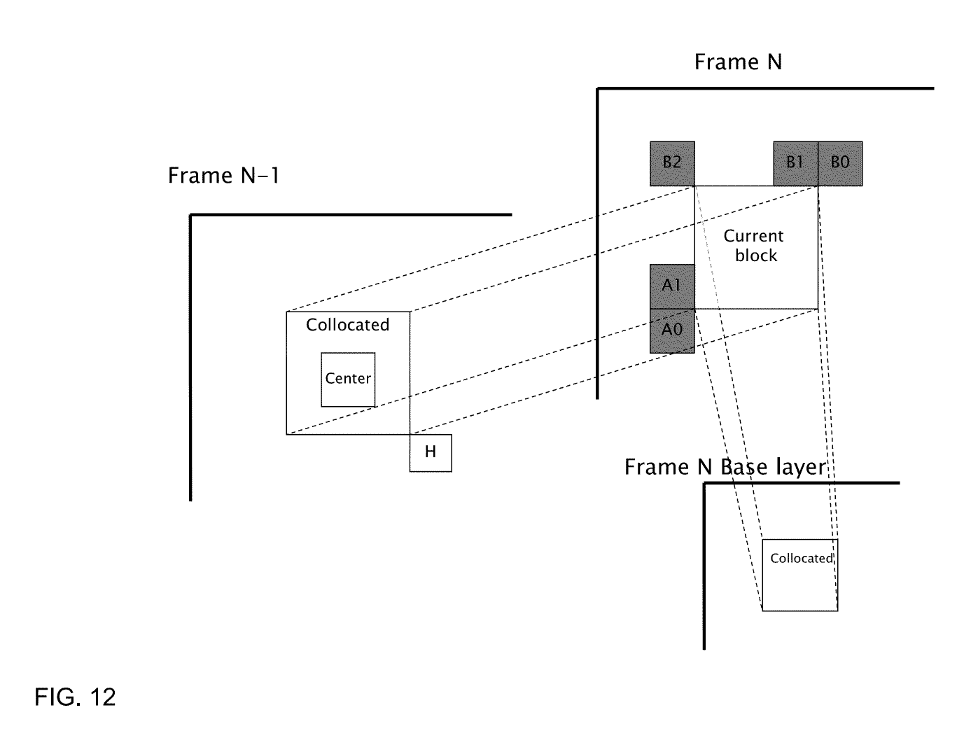

FIG. 12 schematically illustrates the spatial positions of the block which contains the motion vector predictors which could be used in the scalable derivation process of motion vector candidates for Merge and Inter modes. Compared to FIG. 9 the collocated block from the base layer is added.

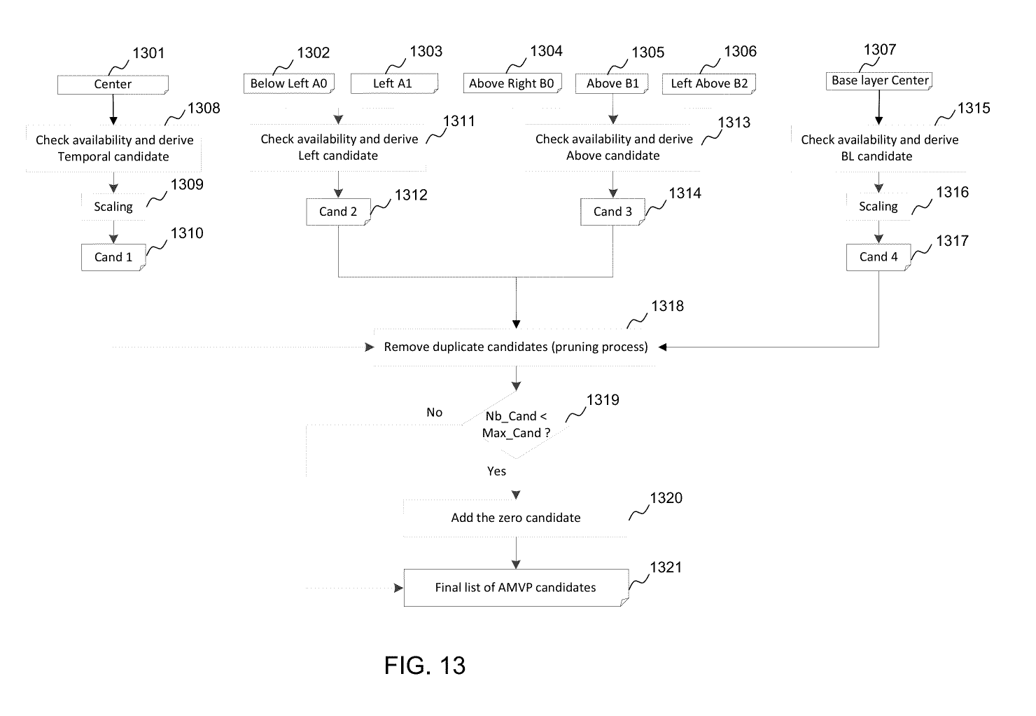

FIG. 13 shows an example of an AMVP predictors set derivation when the base layer motion vector is added in the list. In this example, the base motion vector is the collocated center position as shown in FIG. 12.

Motion information can be included in two lists. Each list contains a reference frame index and a motion vector. In an embodiment of the invention, when the motion information of the collocated base layer block is composed of 2 lists, each list is used to generate an additional base mode.

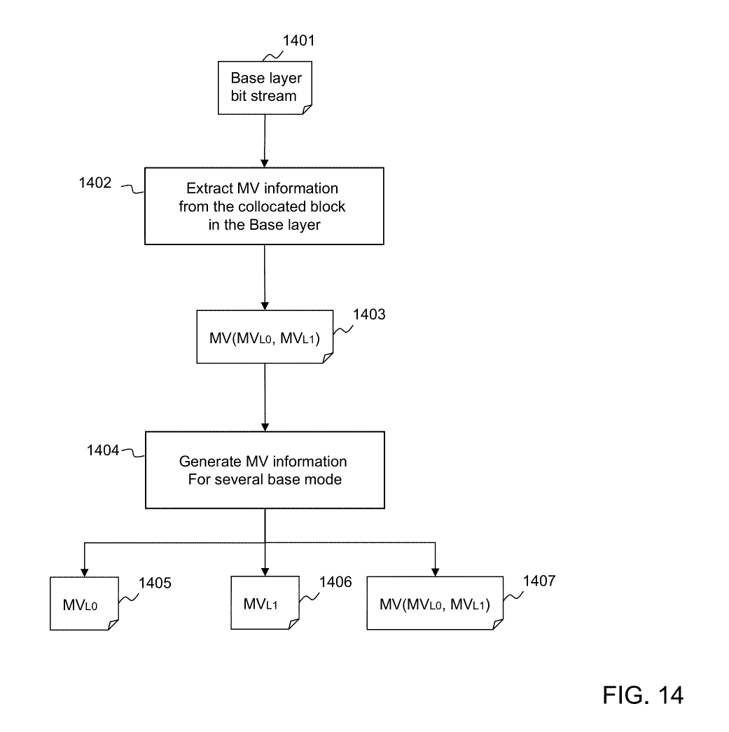

FIG. 14 is a flow chart of a method of deriving prediction information in accordance with one embodiment of the invention in which the motion information of the collocated block of the base layer is used to provide several base mode predictors. The motion information 1403 from the collocated block in the base layer is extracted (1402) from the bitstream or the syntax of the base layer 1401. This motion information MV(MV_{L0}, MV_{L1}) can include 2 motion information parts MV_{L0} and MV_{L1}. Each of the information parts contains one reference frame index respectively Ref_{L0} and Ref_{L1} and one motion vector respectively (mv_{L0x}, mv_{L0y}) and (mv_{L1x}, mv_{L1y}). MV_{L0} denotes the motion information for list L0 which contains Ref_{L0} and (mv_{L0x}, mv_{L0y}) and MV_{L1} denotes the motion information for list L1 which contains Ref_{L1} and (mv_{L1x}, mv_{L1y}). This motion information is then derived 1404 into several motion information parts 1405, 1406, 1407.

As illustrated in FIG. 14, one possible process applied by module 1404 is to extract the motion information from list L0 and list L1 in order to create 2 additional unidirectional motion information parts 1405 1406, in addition to the bidirectional motion information extracted from the Base layer 1407.

In another embodiment, in order to reduce the complexity of the base mode only the unidirectional motion information 1405 and 1406 are kept to create 2 base modes. Indeed, the use of only unidirectional motion compensation is less complex than the bi directional mode.

In another embodiment, when the initial motion information from the base mode is not bidirectional (unidirectional), a miss list information is created. For the following example, it is considered that the motion information of list L0 is available and the motion information of list L1 is missed. One possibility for generating the miss motion information is to scale the motion vector from the reference frame of list L0 to the reference frame of list L1. If the reference frame index of list L0 and list L1 refers to the same reference frame, another reference frame index for list L1 is considered and the motion vector of list L0 is scaled. If L1 has only one reference frame in the list, the motion vector of list L0 is copied to list 1 but one offset is added to one or both components, in order to avoid bidirectional prediction with exactly the same motion vector.

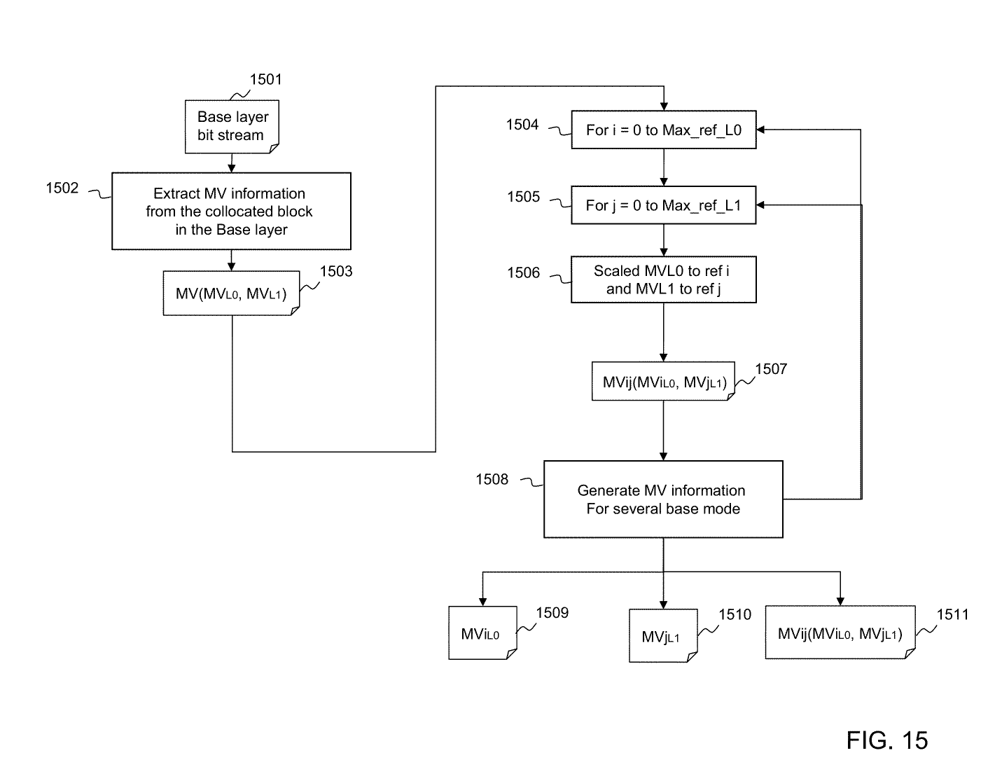

FIG. 15 is a flow chart of another embodiment of the invention combined with the embodiment of FIG. 14. In FIG. 15, the motion information from the base layer is scaled in order to produce several motion candidates to generate several base modes. The motion information 1503 from the collocated block in the base layer is extracted 1502 from the bitstream or the syntax of the base layer 1501. Then, in order to create all possible motion candidates MVᵢⱼ(MV_{iL0}, MV_{jL1}) 1507 two loops are applied to the reference frame index of list L0 and L1 1504 1505. Then the motion vectors (mv_{L0x}, mv_{L0y}) and (mv_{L1x}, mv_{L1y}) are scaled to the reference frame index i and respectively j in order to generate the motion vectors (mvi_{L0x,} mvi_{L0y}) and (mvj_{L1x}, mvj_{L1y})

As a consequence, Ref_{L0} and Ref_{L1} are respectively set equal to i and j. This process generates the motion vectors information MVᵢⱼ(MV_{iL0}, MV_{jL1}) (1505) where MV_{iL0} is the motion information of list L0 pointed to the reference frame index i (Ref_{L0}=i) and MV_{jL1} is the motion information of list L1 pointed to the reference frame index j (Ref_{L1}=j). Finally the same module as (1404) in FIG. 14, 1508 is applied to generate 3 possible motion candidates for the base mode for each couple of reference frame indexes (i, j). This method offers the possibility to create i×j candidates with bi prediction motion information. Thus when it is combined with the first embodiment i×j×3 motion candidates 1509, 1510, 1511 are created.

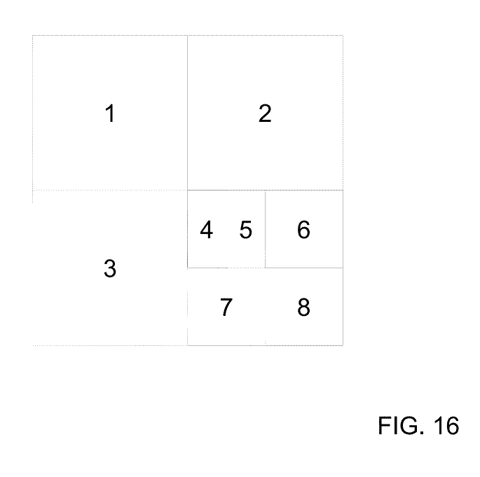

In another embodiment, the multiple motion candidates for the base mode are derived from several motion vectors from the base layer. FIG. 16 shows an example of partitioning of the collocated block of the base layer. This partitioning contains more than one partition. For the classical base mode, the current block is generated by using each motion information for each sub partition in the enhancement layer. In the proposed embodiment, all motion information are used individually for the whole block to generate several base mode block predictors.

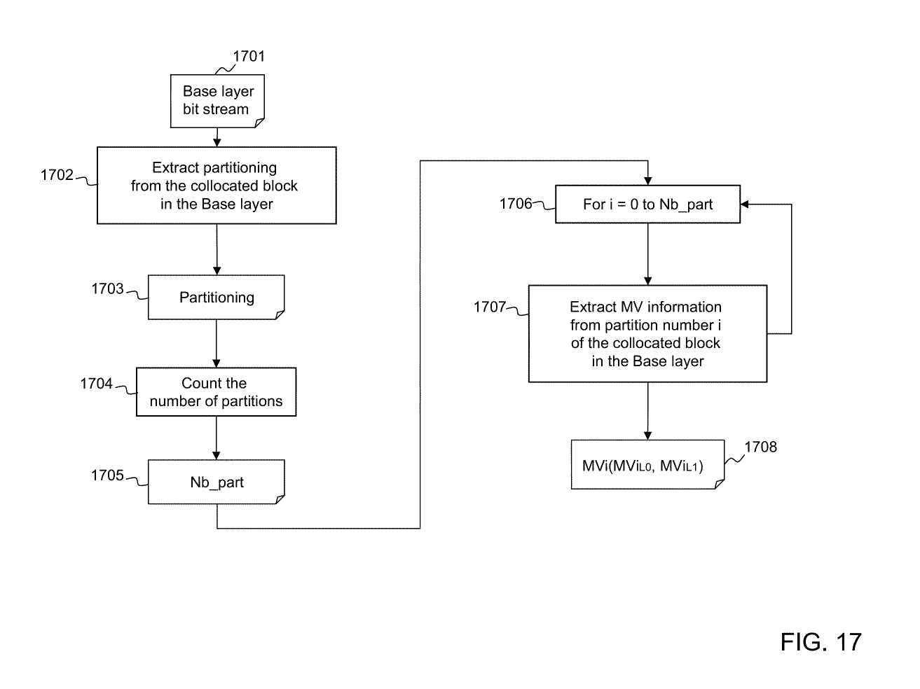

FIG. 17 is a flow chart of an algorithm for generating several motion candidates for several base modes block predictors. In an initial step, the partitioning 1703 of the collocated block of the base layer is extracted 1702 from the base layer bitstream or from the base layer syntax 1701. Then, the number of partitions 1705 in this partitioning 1703 is counted 1704. Then a loop on each partition is used to extract 1707 the motion information MVi(MVi_{L0}, MVi_{L1}) of each of these partitions 1708. In this FIG. 17, MVi(MVi_{L0}, MVi_{L1}) denotes the motion information of partition number i.

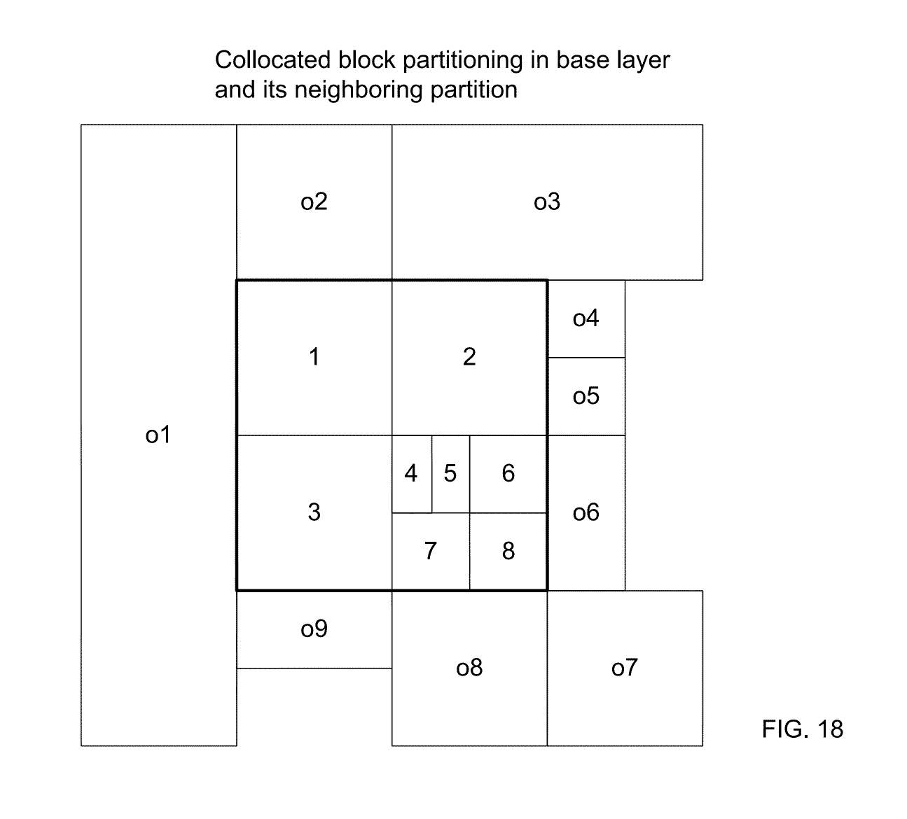

The neighboring motion partitions of the current collocated block in the base layer can be also considered. FIG. 18 shows the neighboring partitions of the collocated block in the base layer. In this case, the same algorithm as depicted in FIG. 17 can be applied to extract the motion information in neighboring partitions oj in order to create several motion candidates for several base modes.

In a further embodiment, the motion vector of the neighboring partition of the current block in the enhancement layer can also be considered as motion vector information for the base mode.

In another embodiment, the temporal collocated motion vector can also be considered for the base mode.

In yet another embodiment, all proposed MV generations for the base mode can be used to replace the base motion vector used in AMVP and Merge mode for scalable video coding. In another embodiment, all proposed MV generations for the base mode can be added to the list of candidates or as predictors for respectively the Merge and AMVP derivation.

It is also known that HEVC restricts the sizes of the Prediction Units (PUs) included in a 8×8 CU to minimal sizes:
PUs should be either 8×4 or 4×8 in case of unidirectional inter or merge PUs (i.e., no 4×4 PUs)
PUs should be 8×8 in case of Bidirectional inter or merge PUs.

This creates an issue when the number of motion information inherited from the co-located reference layer CUs of an enhancement CU to process is above the number of motion information admissible for said enhancement CU due to the PU size restriction.

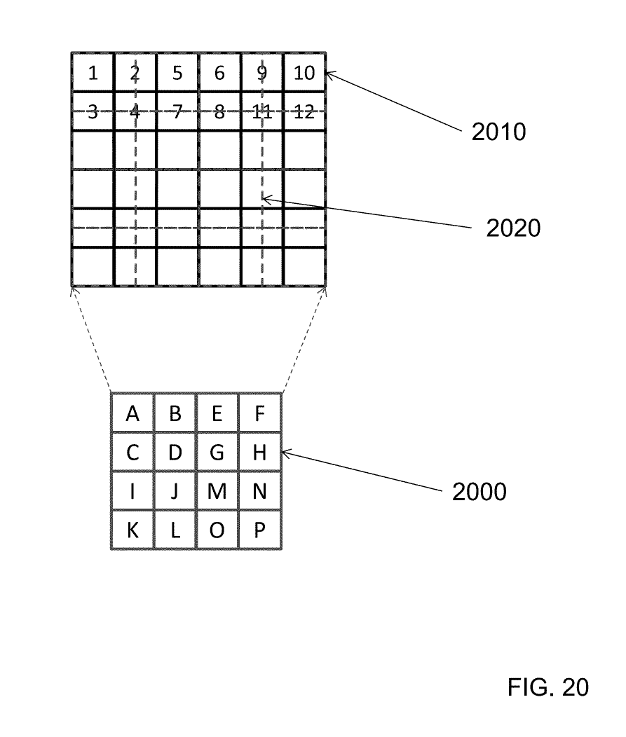

In FIG. 20, a base layer frame 2000 and an enhancement layer frame 2010 are represented, each frame being constituted of a regular grid of 8×8

CUs. In this example the resolution ratio between the base and the enhancement layer is 1.5. In FIG. 20, the reference 2020 is the result of the interpolation of the grid of the base layer frame. As can been some CUs of the enhancement layer (for instance CU 2, 3 and 4) inherit their motion information from several co-located CU in the base layer. CU 2 inherits its motion information from CU A and B. This CU can be divided in 2 unidirectional inter or merge PUs. However this solution clearly limits the number of base mode predictors that can be obtained for CU 2. CU 4 inherits its motion information from CU A, B, C and D which would induce the division of CU 4 into 4 PU which is not authorized by the standard.

In one embodiment, it is proposed to construct further base mode predictors based on this restriction.

In the case of CU 2, 2 additional bi-predicted base mode predictors are added. To do so, and since a bidirectional 8×8 CU can only be divided in 1 8×8 PU, it is proposed to construct a first base mode predictor with the motion of CU A and a second predictor with the motion of CU B.

In the case of CU 4, 4 additional bi-predicted predictors are added. To do so, and again since bidirectional 8×8 CU can only be divided in 1 8×8 PU, a first base mode predictor is constructed with the motion of CU A, a second predictor with the motion of CU B, a third predictor with the motion of CU C and a fourth predictor with the motion of CU D.

In another embodiment where the number of additional base mode predictors is limited, one of the predictors created in case of CU 2 and CU 4 is selected. In one embodiment, the selected predictor could be selected randomly or one of the predictor could be selected systematically. Some tests have shown that the predictor closest to the bottom right corner of the CU provides the best compression results. Indeed, this base mode predictor is associated with a motion information inherited from a co-located block that is close to the neighboring right CU and bottom CU in the enhancement frame. As a consequence this motion information would be a good predictor for predicting the motion information of the next block to process. In the example of CU 2, this means selecting the CU constructed with the motion information of CU B while in case of CU 4, this means selecting the CU constructed with the motion information of CU D.

In another embodiment the constructed base mode predictors could be associated with a code word depending of their probability of occurrence in the frame or in the video sequence.

In more general embodiments adapted to any resolution ratio between the base layer and the enhancement layer, it is proposed to construct as much base mode bi-directional predictors as there are different motion information inherited from the base layer co-located CU. Each constructed bi-directional base mode predictor uses one of the inherited motion information. In other embodiments, combinations of the motion information of the co-located CUs of the base layer could also be computed to construct additional predictors. A possible combination could be an average over all the motion information of the co-located block of the base layer.

In those general embodiments, if only one base mode predictor needs to be constructed, then this predictor uses the motion information of the co-located CU of the base layer closest to the bottom-right corner of the CU to be processed.

Another way of generating several base modes is to use several methods for motion compensation. Indeed as previously mentioned, a GRILP motion compensation mode can be used for Enhancement layer in a scalable video codec.

In one embodiment, traditional motion compensation can be used to generate a base mode block predictor, and the GRILP motion compensation can be used to generate a second base mode block predictor. In this embodiment, the same motion vector can be used to generate both block predictors.

In another embodiment, one or several equations 1.1 to 1.9 defining the generation of GRILP motion compensation can be used independently to generate a block predictor for the base mode.

When considering equation 1.3 of GRILP motion compensation previously described, the 3 parameters λ, α, β can be varied in order to produce several block predictors for the base mode.

In one embodiment, GRILP motion compensation is used to generate one base mode predictor and the second one is obtained by averaging the first block predictor and the Intra BL block predictor pixel by pixel.

In another embodiment filtering is applied to one or more base mode block predictors. In one embodiment the post filtering of the classical video codec, such as the deblocking filter and SAO of the HEVC standard is applied. Other filters may also be considered as ALF or wiener filters, or other low pass and high pass filters. While systematically applying one or more filters may be optimal in some cases, in other cases it is better to disable the filtering. In some embodiments of the present invention, the filtering can be applied to one base mode block predictor and disabled in another base mode block predictor.

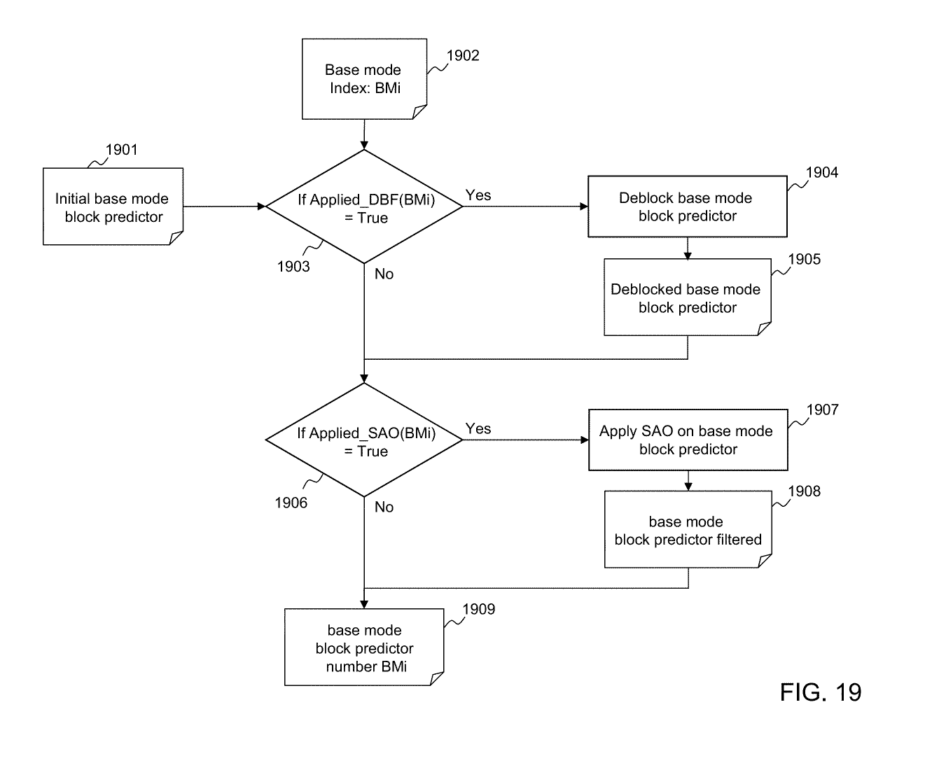

FIG. 19 shows one example of applying the previous embodiment. In this embodiment the index of the base mode BMi corresponds to the filter or the set of filters which is or are applied to the initial base mode block predictor (1901). In this example, only the deblock filter (DBF) and the SAO are considered. The input data of this process is the base mode index 1902 and the initial base mode block predictor 1901. The decision module 1903 checks if the current base mode requires the deblocking filter. Thus, the decision module 1903 checks if the base mode index BMi corresponds to a base mode with a deblocking filter. If it requires a deblocking filter, the initial base mode block predictor is deblocked 1904 in order to produce the deblocked base mode predictor 1905. Then the decision module 1906 checks if the SAO filter needs to be applied on the base mode predictor. If yes the SAO filtering is applied 1907 to produce an SAO filtered block predictor for the base mode 1908. At the end of the process the base mode block predictor related to the base mode index BMi is generated. With the algorithm example of FIG. 19, 4 different base mode block predictors should compete at the encoder side.

In another embodiment, the order of the filters also competes. In the example of FIG. 19 the deblocking filter should be applied before or after SAO. This offers an additional base mode predictor.

All proposed embodiments for generating base mode predictors as previously described can be combined.

When several base mode predictors compete against one another at the encoder side, the selected base mode predictor should be determined at the decoder side. A simple way of achieving that is to insert into the bitstream an index corresponding to the same base mode predictor at the encoder and decoder sides. This index can be coded, for example by an unary max code, where the maximum value is set equal to a fixed value. To improve the coding efficiency, the amount of base mode predictors can be determined on the fly. For example, when the multiple base mode predictors generation is based on the motion information, the number of motion candidates available to generate base mode predictors can be determined by comparing the candidates to identify the number of unique candidates. When the base mode predictors are generated by modifying the motion compensation, the block predictors generated for each motion compensation can be compared to identify the number of unique block predictors. An alternative for determining if the GRILP base mode block predictors need to be used in the set of base mode block predictors, is to check if the collocated base layer has a block residual.

Another alternative to avoid signaling the base mode predictors index is to build the left and upper border of the block predictor and to compare it with the already reconstructed signaling of the current enhancement layer (the neighboring encoded/decoded pixels). The base mode predictor which gives the minimum distortion on the border of the current block is selected at the encoder and decoder sides.

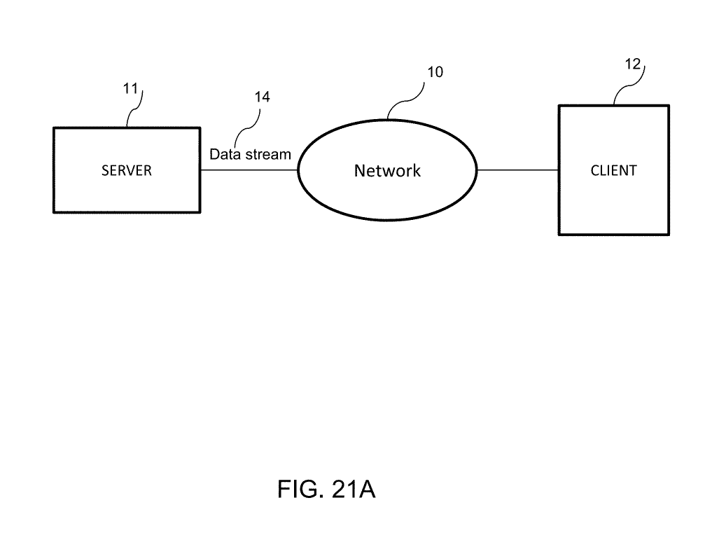

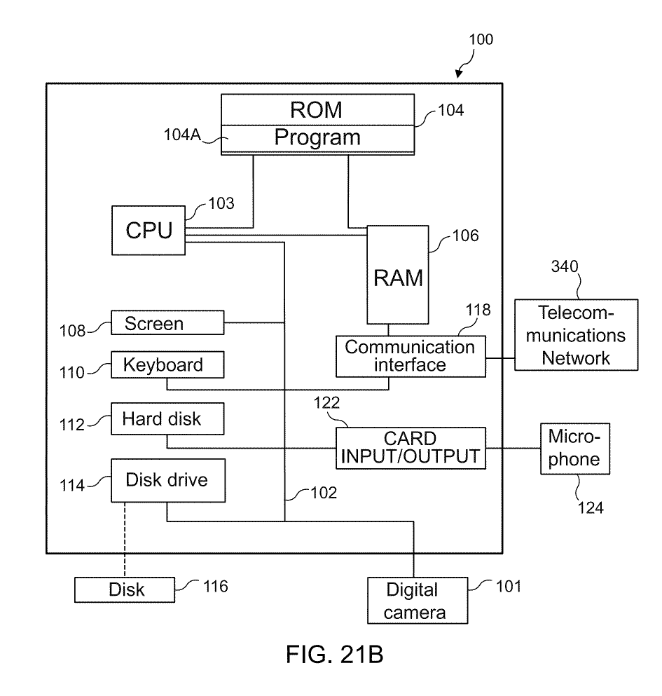

FIG. 21A schematically illustrates a data communication system in which one or more embodiments of the invention may be implemented. The data communication system comprises a sending device, in this case a server 11, which is operable to transmit data packets of a data stream 14 to a receiving device, in this case a client terminal 12, via a data communication network 10. The data communication network 10 may be a Wide Area Network (WAN) or a Local Area Network (LAN). Such a network may be for example a wireless network (Wifi/802.11a or b or g or n), an Ethernet network, an Internet network or a mixed network composed of several different networks. In a particular embodiment of the invention the data communication system may be, for example, a digital television broadcast system in which the server 11 sends the same data content to multiple clients.

The data stream 14 provided by the server 11 may be composed of multimedia data representing video and audio data. Audio and video data streams may, in some embodiments, be captured by the server 11 using a microphone and a camera respectively. In some embodiments data streams may be stored on the server 11 or received by the server 11 from another data provider. The video and audio streams are coded by an encoder of the server 11 in particular for them to be compressed for transmission.

In order to obtain a better ratio of the quality of transmitted data to quantity of transmitted data, the compression of the video data may be of motion compensation type, for example in accordance with the HEVC type format or H.264/SVC type format.

A decoder of the client 12 decodes the reconstructed data stream received by the network 10. The reconstructed images may be displayed by a display device and received audio data may be reproduced by a loud speaker.

FIG. 21B schematically illustrates an example of a device 100, in which one or more embodiments of the invention may be implemented. The exemplary device as illustrated is arranged in cooperation with a digital camera 101, a microphone 124 connected to a card input/output 122, a telecommunications network 340 and a disk 116. The device 100 includes a communication bus 102 to which are connected:
a central processing CPU 103 provided, for example in the form of a microprocessor
a read only memory (ROM) 104 comprising a computer program 104A whose execution enables methods according to one or more embodiments of the invention to be performed. This memory 104 may be a flash memory or EEPROM, for example;
a random access memory (RAM) 106 which, after powering up of the device 100, contains the executable code of the program 104A necessary for the implementation of one or more embodiments of the invention. The memory 106, being of a random access type, provides more rapid access compared to ROM 104. In addition the RAM 106 may be operable to store images and blocks of pixels as processing of images of the video sequences is carried out on the video sequences (transform, quantization, storage of reference images etc.);
a screen 108 for displaying data, in particular video and/or serving as a graphical interface with the user, who may thus interact with the programs according to embodiments of the invention, using a keyboard 110 or any other means e.g. a mouse (not shown) or pointing device (not shown);
a hard disk 112 or a storage memory, such as a memory of compact flash type, able to contain the programs of embodiments of the invention as well as data used or produced on implementation of the invention;
an optional disc drive 114, or another reader for a removable data carrier, adapted to receive a disc 116 and to read/write thereon data processed, or to be processed, in accordance with embodiments of the invention and;
a communication interface 118 connected to a telecommunications network 340
connection to a digital camera 101; It will be appreciated that in some embodiments of the invention the digital camera and the microphone may be integrated into the device 100 itself. Provision of a digital camera and a microphone is optional.

The communication bus 102 permits communication and interoperability between the different elements included in the device 100 or connected to it. The representation of the communication bus 102 given here is not limiting. In particular, the CPU 103 may communicate instructions to any element of the device 100 directly or by means of another element of the device 100.

The disc 116 can be replaced by any information carrier such as a compact disc (CD-ROM), either writable or rewritable, a ZIP disc, a memory card or a USB key. Generally, an information storage means, which can be read by a micro-computer or microprocessor, which may optionally be integrated in the device 100 for processing a video sequence, is adapted to store one or more programs whose execution permits the implementation of the method according to the invention.

The executable code enabling a coding device to implement one or more embodiments of the invention may be stored in ROM 104, on the hard disc 112 or on a removable digital medium such as a disc 116.

The CPU 103 controls and directs the execution of the instructions or portions of software code of the program or programs of embodiments of the invention, the instructions or portions of software code being stored in one of the aforementioned storage means. On powering up of the device 100, the program or programs stored in non-volatile memory, e.g. hard disc 112 or ROM 104, are transferred into the RAM 106, which then contains the executable code of the program or programs of embodiments of the invention, as well as registers for storing the variables and parameters necessary for implementation of embodiments of the invention.

It may be noted that the device implementing one or more embodiments of the invention, or incorporating it, may be implemented in the form of a programmed apparatus. For example, such a device may then contain the code of the computer program or programs in a fixed form in an application specific integrated circuit (ASIC).

The exemplary device 100 described here and, particularly, the CPU 103, may implement all or part of the processing operations as described in what precedes.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:
obtaining prediction data of at least a co-located elementary unit of the reference data, the prediction data defining first predictors; and
generating, from said prediction data obtained, further predictors for prediction of the current processing block,
wherein the prediction data comprises motion data indicative of the location of the corresponding predictor in the video data; and in the case where the motion data is bidirectional comprising two motion data sets, the method comprising generating at least one set of unidirectional motion data from the bidirectional motion data for the further predictors.

2. A method according to claim 1, wherein the predictor is selected from the further predictors of the unidirectional data for prediction of the processing block.

3. A method according to claim 1, wherein if one of the two motion data sets is missing the further predictors are derived from the single motion data set to provide at least a second motion data set.

4. A method according to claim 3, wherein motion vectors of a reference frame in the single motion data set are scaled to the corresponding reference frame of the second motion data set.

5. A method according to claim 3, wherein if a frame reference of the single motion data set refers to the same reference frame as the second motion data set the frame reference of the second motion data set is changed to another frame reference of the second motion data set.

6. A method according to claim 3, wherein the corresponding motion vector of the reference frame defined in the second motion data set is modified in the case where the second motion data set defines only one reference frame.

7. A method according to claim 1, further comprising scaling motion vectors of the first predictors to obtain motion vectors of the further predictors.

8. A method according to claim 1, wherein prediction data is obtained from each sub-unit of the co-located elementary unit for generation of the second set of candidate predictors.

9. A method according to claim 8 wherein prediction data is obtained from one or more sub-units neighbouring the co-located elementary unit for generation of the further predictors.

10. A method according to claim 1, wherein prediction data is obtained from one or more sub-processing blocks of the enhancement layer neighbouring the said processing block for generation of the further predictors.

11. A method according to claim 1, wherein prediction data is obtained from a temporal co-located elementary unit for generation of the further predictors.

12. A method according to claim 1, wherein a predictor from the further predictors is selectable as for a predictor for use in AMVP and/or merge mode processes

13. A method according to claim 1, wherein at least one filtering process is applied to one or more predictors of the first predictors to obtain the further predictors.

14. A method according to claim 1, wherein a first predictor is used to generate at least two predictors of the further predictors by application of at least two different respective motion compensation processes.

15. A method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:
obtaining prediction data of at least a co-located elementary unit of the reference data, the prediction data defining first predictors; and
generating, from said prediction data obtained, further predictors for prediction of the current processing block.
wherein the prediction data comprises motion data indicative of the location of the corresponding predictor in the video data and a motion vector of the prediction data is used to generate at least two predictors of the further predictors by application of at least two different respective motion compensation processes.

16. A method according to claim 15 wherein at least one of the motion compensation processes comprises predicting a temporal residual of the enhancement layer processing block from a temporal residual computed between a collocated elementary unit of the base layer and a reference elementary unit of the base layer determined in accordance with motion information of the enhancement layer.

17. A method according to claim 16 wherein the said at least one motion compensation process is defined respectively by at least one of the following expressions:
PRED_{EL}=MC₁[REF_{EL},MV_{EL}]+{UPS[REC_{BL}−MC₄[REF_{BL},MV_{EL}/2]]}
PRED_{EL}=λMC₁[REF_{EL},MV_{EL}]+α{UPS[REC_{BL}−βMC₄[REF_{BL},MV_{EL}/2]]}
PRED_{EL}=MC₁[REF_{EL},MV_{EL}]+{UPS[REC_{BL}]−FILT₁(MC₂[UPS[REF_{BL}],MV_{EL}])}
PRED_{EL}=UPS[REC_{BL}]+FILT₁(MC₃[REF_{EL}−UPS[REF_{BL}],MV_{EL}])
PRED_{EL}=MC₁[REF_{EL},MV_{EL}]+FILT₁({UPS[REC_{BL}−MC₄[REF_{BL},MV_{EL}/2]]})
PRED_{EL}=FILT₂(MC₁[REF_{EL},MV_{EL}])+{UPS[REC_{BL}]−FILT₁(MC₂[UPS[REF_{BL}],MV_{EL}])}
PRED_{EL}=FILT₂(UPS[REC_{BL}])+FILT₁(MC₃[REF_{EL}−UPS[REF_{BL}],MV_{EL}])
PRED_{EL}=FILT₂(MC₁[REF_{EL},MV_{EL}])+FILT₁({UPS[REC_{BL}−MC₄[REF_{BL},MV_{EL}/2]]}
where:
PRED_{EL} corresponds to the prediction of the current processing block,
REC_{BL} is the co-located elementary unit from the reconstructed base layer image, corresponding to the current enhancement layer,
MV_{EL} is the motion vector used for the temporal prediction in the enhancement layer
REF_{EL} is the reference enhancement layer image,
REF_{BL} is the reference base layer image,
UPS[x] is the upsampling operator for upsampling from the base layer to the enhancement layer
MC₁[x,y] is the enhancement layer operator performing the motion compensated prediction from image x using motion vector y
MC₂[x,y] is the base layer operator performing the motion compensated prediction from image x using the motion vector y

18. A method according to claim 16 wherein the said at least one motion compensation process is defined by
PRED_{EL}=λMC₁[REF_{EL},MV_{EL}]+α{UPS[REC_{BL}−βMC₄[REF_{BL},MV_{EL}/2]]}
wherein at least one of the parameters λ, α, β is varied to obtain a plurality of predictor candidates for the further predictors.

19. A method according to claim 15, wherein the plurality of predictors obtained by the plurality of motion compensation processes are averaged to obtain a candidate predictor.

20. A method of processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the method comprising for a processing block of the enhancement layer:
obtaining prediction data of at least a co-located elementary unit of the reference data, the prediction data defining first predictors; and
generating, from said prediction data obtained, further predictors for prediction of the current processing block.
wherein at least one filtering process is applied to one or more predictors of the first predictors to obtain the further predictors

21. A method according to claim 20, wherein the filtering process comprises at least one filter selected from the group of deblocking filter, SAO filter, ALF filter, and Weiner filter

22. A method according to claim 1, further comprising determining the number of unique predictor candidates among the first predictors and further predictors, or among the further predictors.

23. A method according to claim 1, further comprising selecting, based on a rate-distortion criteria, a predictor from among the first predictors and the further predictors.

24. A method according to claim 23 further comprising signalling indicator data representative of the selected predictor.

25. A method according to claim 24 wherein the indicator data comprises an index coded by a unary max code wherein the maximum value is set to a fixed value

26. A method according to claim 1, further comprising selecting, based on a rate-distortion criteria, a predictor from among the further predictors.

27. A method according to claim 26, further comprising signalling indicator data representative of the selected predictor.

28. A method according to claim 27 wherein the indicator data comprises an index coded by a unary max code wherein the maximum value is set to a fixed value

29. A method according to claim 1, comprising identifying unique predictors of the first predictors.

30. A method according to claim 1, comprising identifying unique predictors of the further predictors.

31. A method according to claim 1, comprising identifying if the at least one co-located elementary unit of the base layer has a block residual.

32. A method according to claim 1, wherein predicted border processing blocks are compared with reconstructed border processing blocks and the predictor providing the minimum distortion between the predicted and the reconstructed border processing blocks is selected.

33. A device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:
a prediction data extractor for obtaining, for a processing block of the enhancement layer, prediction data of at least a co-located elementary unit of the reference data, the prediction data defining first predictors the prediction data comprising motion data indicative of the location of the corresponding predictor in the video data; and
a predictor data generator for generating, from said prediction data obtained further predictors for prediction of the current processing block.
wherein the predictor data generator is configured to generate at least one set of unidirectional motion data from bidirectional motion data for the further predictors in the case where the motion data is bidirectional comprising two motion data set.

34. A device according to claim 33, wherein the predictor is selected from the further predictors of the unidirectional data for prediction of the processing block.

35. A device according to claim 33, wherein if one of the two motion data sets is missing the predictor data generator is configured to derive the further predictors from the single motion data set to provide at least a second motion data set.

36. A device according to claim 35, comprising a scaler for scaling motion vectors of a reference frame in the single motion data set to the corresponding reference frame of the second motion data set.

37. A device according to claim 35 wherein if a frame reference of the single motion data set refers to the same reference frame as the second motion data set the frame reference of the second motion data set is changed to another frame reference of the second motion data set.

38. A device according to claim 35 wherein the corresponding motion vector of the reference frame defined in the second motion data set is modified in the case where the second motion data set defines only one reference frame.

39. A device according to claim 33, further comprising a motion vector scaler for scaling motion vectors of the first motion data set to obtain motion vectors of the further predictors.

40. A device according to claim 33, wherein the prediction data extractor is configured to obtain prediction data from each sub-unit of the co-located elementary unit for generation of the further predictors.

41. A device according to claim 40 wherein the prediction data extractor is configured to obtain prediction data from one or more sub-units neighbouring the co-located elementary unit for generation of the further predictors.

42. A device according to claim 33, wherein the prediction data extractor is configured to obtain prediction data from one or more sub-processing blocks of the enhancement layer neighbouring the said processing block for generation of the further predictors.

43. A device according to claim 33, wherein the prediction data extractor is configured to obtain prediction data from a temporal co-located elementary unit for generation of the further predictors.

44. A device according to claim 33, wherein a predictor from the further predictors is selectable as a predictor for use in AMVP or merge mode processes

45. A device according to claim 33, further comprising a filter for applying at least one filtering process is applied to one or more predictors of the first predictors to obtain the further predictors and/or the prediction data generator is configured to obtain a motion vector of the prediction data to generate at least two predictors of the further predictors by application of at least two different respective motion compensation processes.

46. A device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:
a prediction data extractor for obtaining, for a processing block of the enhancement layer, prediction data of at least a co-located elementary unit of the reference data, the prediction data defining first predictors; and
a predictor data generator for generating, from said prediction data obtained, further predictors for prediction of the current processing block;
wherein the prediction data comprises motion data indicative of the location of the corresponding predictor in the video data; and the prediction data generator is configured to obtain a motion vector of said prediction data to generate at least two predictors of the further predictors by application of at least two different respective motion compensation processes.

47. A device according to claim 46 wherein at least one of the motion compensation processes comprises predicting a temporal residual of the enhancement layer processing block from a temporal residual computed between a collocated elementary unit of the base layer and a reference elementary unit of the base layer determined in accordance with motion information of the enhancement layer.

48. A device according to claim 47 wherein the said at least one motion compensation process is defined respectively by at least one of the following expressions:
PRED_{EL}=MC₁,[REF_{EL},MV_{EL}]+{UPS[REC_{BL}−MC₄[REF_{BL},MV_{EL}/2]]}
PRED_{EL}=λMC₁[REF_{EL},MV_{EL}]+α{UPS[REC_{BL-βMC}₄[REF_{BL},MV_{EL}/2]]}
PRED_{EL}=MC₁[REF_{EL},MV_{EL}]+{UPS[REC_{BL}]−FILT₁(MC₂[UPS[REF_{BL}],MV_{EL}])}
PRED_{EL}=UPS[REC_{BL}]+FILT₁(MC₃[REF_{EL}−UPS[REF_{BL}],MV_{EL}])
PRED_{EL}=MC₁[REF_{EL},MV_{EL}]+FILT₁({UPS[REC_{BL}−MC₄[REF_{BL},MV_{EL}/2]]})
PRED_{EL}=FILT₂(MC₁[REF_{EL},MV_{EL}])+{UPS[REC_{BL}]−FILT₁(MC₂[UPS[REF_{BL}],MV_{EL}])}
PRED_{EL}=FILT₂(UPS[REC_{BL}])+FILT₁(MC₃[REF_{EL}−UPS[REF_{BL}],MV_{EL}])
PRED_{EL}=FILT₂(MC₁[REF_{EL},MV_{EL}])+FILT₁({UPS[REC_{BL}−MC₄[REF_{BL},MV_{EL}/2]]}
where:
PRED_{EL} corresponds to the prediction of the current processing block,
REC_{BL} is the co-located elementary unit from the reconstructed base layer image, corresponding to the current enhancement layer,
MV_{EL} is the motion vector used for the temporal prediction in the enhancement layer
REF_{EL} is the reference enhancement layer image,
REF_{BL} is the reference base layer image,
UPS[x] is the upsampling operator for upsampling from the base layer to the enhancement layer
MC₁[x,y] is the enhancement layer operator performing the motion compensated prediction from image x using motion vector y
MC₂[x,y] is the base layer operator performing the motion compensated prediction from image x using the motion vector y

49. A device according to claim 47 wherein the said at least one motion compensation process is defined by
PRED_{EL}=λMC₁[REF_{EL},MV_{EL}]+α{UPS[REC_{BL}−βMC₄[REF_{BL},MV_{EL}/2]]}
the device further comprising means to vary at least one of the parameters λ, α, β to obtain a plurality of predictor candidates for the further predictors.

50. A device according to claim 46, wherein the plurality of predictors obtained by the plurality of motion compensation processes are averaged to obtain a candidate predictor.

51. A device for processing prediction information for encoding or decoding at least part of an image of an enhancement layer of video data, the video data including the enhancement layer and a base layer, the enhancement layer being composed of processing blocks and the base layer being composed of elementary units each having associated prediction data defining at least one predictor for prediction of the elementary unit, the device comprising:
a prediction data extractor for obtaining, for a processing block of the enhancement layer, prediction data of at least a co-located elementary unit of the reference data, the prediction data defining first predictors;
a predictor data generator for generating, from said prediction data obtained, further predictors for prediction of the current processing block; and
a filter for applying at least one filtering process to one or more predictors of the first set of predictors to obtain the further predictors.

52. A device according to claim 51, wherein the filtering process comprises at least one filter selected from the group of deblocking filter, SAO filter, ALF filter, and Weiner filter

53. A device according to claim 33, further comprising a processor for determining the number of unique predictor candidates in the first and further predictor candidates, or in the further predictor candidates

54. A device according to claim 33, further comprising a selector for selecting, based on a rate-distortion criteria, a predictor candidate from among the first set of predictors and the further predictors.

55. A device according to claim 54, further comprising signalling means for signalling indicator data representative of the selected predictor candidate.

56. A device according to claim 55, wherein the indicator data comprises an index coded by a unary max code wherein the maximum value is set to a fixed value.

57. A device according to claim 33, further comprising a selector for selecting, based on a rate-distortion criteria, a predictor candidate from among the further predictors.

58. A device according to claim 57, further comprising signalling means for signalling indicator data representative of the selected predictor candidate.

59. A device according to claim 58, wherein the indicator data comprises an index coded by a unary max code wherein the maximum value is set to a fixed value

60. A device according to claim 33, further comprising a unique predictor identifier for identifying unique predictors of the first set of predictors.

61. A device according to claim 33, further comprising a unique predictor identifier for identifying unique predictors of the further predictors.

62. A device according to claim 33, further comprising a block residual identifier for identifying if the at least one co-located elementary unit of the base layer has a block residual.

63. A device according to claim 33, further comprising a comparator for comparing predicted border processing blocks with reconstructed border processing blocks wherein the selector is configured to select the predictor providing the minimum distortion between the predicted and the reconstructed border processing blocks.

64. A method of determining prediction information for encoding or decoding at least part of an image of an enhancement layer of video data, the video data including the enhancement layer and a base layer, the enhancement layer being composed of processing blocks and the base layer being composed of elementary units, the method comprising for each enhancement layer's processing block
determining interlayer predictors from the collocated base layer's elementary units for processing the processing blocks, taking into account prediction constraints on the processing blocks.

65. A method according to claim 64, wherein there is one determined interlayer predictor per enhancement layer processing block, the determined interlayer predictor being associated with the portion of the processing block which is the closest to the bottom right corner of the processing block.

66. A non-transitory computer-readable medium having computer readable instructions stored thereon which when executed by a computer cause the computer to perform a method according to claim 1.
